(19) United States
(12) Patent Application Publication
(10) Pub. No.: US 2015/0311522 A1
(43) Pub. Date: Oct. 29, 2015

(54) POSITIVE ACTIVE MATERIAL FOR USE IN A LITHIUM ION BATTERY AND METHOD FOR PREPARING THE SAME

(71) Applicant: Ningde Amperex Technology Limited, Ningde (CN)

(72) Inventors: Xiangpeng Fang, Ningde (CN); Xuguang Gao, Ningde (CN); Na Liu, Ningde (CN)

(73) Assignee: Ningde Amperex Technology Limited

(21) Appl. No.: 14/693,904

(22) Filed: Apr. 23, 2015

(30) Foreign Application Priority Data
Apr. 24, 2014 (CN) 201410167898.1

(51) Int. Cl. H01M 4/485; H01M 4/48; H01M 4/1391; H01M 4/505; H01M 4/36; H01M 4/04; H01M 10/052; H01M 4/525

(52) U.S. Cl. CPC H01M 4/485; H01M 10/052; H01M 4/483; H01M 4/525; H01M 4/505; H01M 4/366; H01M 4/0471; H01M 4/0402; H01M 4/1391; H01M 2004/028

(57) ABSTRACT

The present invention provides a positive active material for use in a lithium ion battery, a method for preparing the positive active material and a lithium ion battery containing the positive active material. The positive active material includes a core of lithium containing transition metal oxide represented by Formula LiₓM_{y}N_{1-y}O_{2-α}A_{β} and a coating layer of lithium containing transition metal phosphate represented by Formula LiₐM_{b}N′_{1-b}PO_{4-λ}B_{ζ} in situ formed on the core, wherein 0.9≦x≦1.2, 0.6≦y≦1.0, 0.9≦a≦1.1, 0.6≦b≦1.0, 0≦α≦0.2, 0≦β≦0.4, 0≦λ≦0.5, 0≦ζ≦0.5. The positive active material for use in a lithium ion battery according to the present invention has high capacity, desirable cycling performance and safety performance, as well as desirable thermal stability.

### CROSS-REFERENCE TO RELATED APPLICATION

The present patent application claims priority to Chinese patent application number CN 201410167898.1 filed on Apr. 24, 2014, which is incorporated by reference herein in its entirety.

### BACKGROUND

The present invention generally relates to lithium ion batteries and, more particularly, relates to a positive active material having desirable performances for use in a lithium ion battery and method for preparing the same.

### DESCRIPTION OF RELATED ART

At present, positive active materials for use in lithium ion batteries generally include spinel structure LiM₂O₄ (M is Co, Ni, Mn), layered lithium containing transition metal oxides LiMO₂ (M is Mn, Co, Ni) and olivine structure lithium phosphate salt LiMPO₄ (M is Fe, Mn, Co, Ni). Layered lithium containing transition metal oxide LiCoO₂ is one of the most popular positive active materials in commercial applications due to simple synthesis process and mature application technology. However, LiCoO₂ still can hardly meet the actual requirements of large lithium ion battery due to high price of cobalt, toxicity of cobalt and poor safety performance, especially cannot meet the requirements of power batteries which have high safety performance and long lifespan.

To improve the electrochemical performance of LiCoO₂, such as safety performance and cycling performance, it is proposed that coating treatment is applied to LiCoO₂. However, LiCoO₂ after coating treatment still cannot meet the requirements of actual use.

Ternary material represented by Formula LiNiₓCo_{y}M_{1-x-y}O₂ is one of the latest positive active materials which have been widely used in lithium ion batteries due to low price, simple synthesis process, high energy density and desirable safety performance. Ternary material represented by Formula LiNiₓCo_{y}M_{1-x-y}O₂ is considered as one of the latest positive active materials which may substitute for LiCoO₂, and may be widely used as positive active materials in hybrid vehicle batteries. However, ternary material represented by Formula LiNiₓCo_{y}M_{1-x-y}O₂ is apt to swell at high voltage and powder after multiple cycles, which may lead to safety accidents of lithium ion batteries due to overcharge or thermal runaway. In order to improve the performance of ternary material, it is proposed that composite including lithium metal phosphate (LiMPO₄) and metal phosphate (M₃(PO4)₂) can be coated on the surface of nickel-based oxide positive active material, so as to improve the safety performance of the lithium ion battery via improving the thermal stability of the positive active material. However, the proposal mentioned above still has the following disadvantages. Firstly, M₃(PO₄)₂ can hardly transmit into LiMPO₄; Secondly, it is difficult to control the ratio of M₃(PO₄)₂ to LiMPO₄; Thirdly, the content of lithium on the surface of nickel-based oxide positive active material has to be higher than that in the core, which will limit the application of the positive active material; Fourthly, the coating layer is formed via sintering the composite deposited on the surface of the core. It is difficult to form complete and compact coating layer. Electrolyte and HF in the electrolyte may contact the core that fails to be coated by the coating layer and react with the core. In addition, the coating layer is physically bonded to the core. Therefore, after long time cycles, the coating layer may peel off from the core and cannot protect the core anymore.

In addition, it has been reported that oxides, such as Al₂O₃, AlPO₄, ZrO₂, TiO₂ and B₂O₃, can be used to coat the positive active materials, so as to improve the surface structural stability of the positive active materials and improve the cycling performance of the lithium ion batteries at high voltage. However, the metal oxides mentioned above for coating the core are all non-electrochemically active materials with poor lithium ion conductivity. Therefore, the coating layer of metal oxides can hardly improve the performances of the positive active materials. Some even may adversely affect the performances of the positive active materials.

What is needed, therefore, is to provide a positive active material having desirable performances for use in lithium ion batteries and method for preparing the same.

### BRIEF SUMMARY

One object of the present invention is to provide a positive active material having high capacity and stability as well as desirable safety performance and cycling performance for use in a lithium ion battery and method for preparing the same. The other object of the present invention is to provide a lithium ion battery which has high capacity and stability as well as desirable safety performance and cycling performance.

According to one embodiment of the present invention, a positive active material for use in a lithium ion battery includes a core of lithium containing transition metal oxide represented by Formula LiₓM_{y}N_{1-y}O_{2-α}A_{β} and a coating layer of lithium containing transition metal phosphate represented by Formula LiₐM_{b}N′_{1-b}PO_{4-λ}B_{ζ} in situ formed on the core, wherein element represented by M is at least one of Ni, Co, Mn; element represented by N and N′ each is at least one of Na, K, Rb, Cs, Be, Mg, Ca, Sr, Ba, Ra, Al, Ga, In, Ge, Sn, Sc, Ti, V, Cr, Mn, Fe, Co, Ni, Cu, Zn, Y, Zr, Nb, Mo, Ru, Rh, Pd, Ag, Cd, La, Ce, Pr, Nd, Sm, Eu, Gd, Tb, Dy, Ho, Er, Tm, Yb, Lu; element represented by A and B each is at least one of N, F, P, S, Cl, Se; and 0.9≦x≦1.2, 0.6≦y≦1.0, 0.9≦a≦1.1, 0.6≦b≦1.0, 0≦α≦0.2, 0≦β≦0.4, 0≦λ≦0.5, 0≦ζ≦0.5.

The coating layer of lithium containing transition metal phosphate represented by Formula LiₐM_{b}N′_{1-b}PO_{4-λ}B_{ζ} has desirable lithium ion conductivity and structural stability. The coating layer of lithium containing transition metal phosphate represented by Formula LiₐM_{b}N′_{1-b}PO_{4-λ}B_{ζ} at least has the following functions.

Inhibiting structure change of the core represented by formula LiₓM_{y}N_{1-y}O_{2-α}A_{β} at high voltage and oxygen evolution: for the core without coating layer formed thereon, when intercalation of lithium ions occurs, element represented by M mainly exists in +4. M⁴⁺ on the surface of the core will change to M³⁺ or M²⁺, which will lead to structure change of the core and oxygen evolution. Because the coating layer is in situ formed on the surface of the core via chemical reaction, the coating layer can be bonded to the surface of the core via stable chemical bonding. Due to the protection of the coating layer, at high voltage, oxygen evolution as well as change of M⁴⁺ into M³⁺ or M²⁺ is inhibited. Therefore, structural stability and cycling performance of the positive active material is remarkably improved.

Preventing the lithium ion battery from swelling via inhibiting the core from catalyzing and oxidizing the electrolyte: the transition metal in the core without lithium insertion mainly exist in +4 has strong catalyzing and oxidizing ability, which may lead to decomposition of the electrolyte and generation of gas and further lead to swelling of the lithium ion battery. After coating of the coating layer, there will be less transition metal having the valence of +4 at the surface of the core, which will reduce the catalyzing and oxidizing ability of the positive active material, and reduce the decomposition of the electrolyte.

Preventing HF in the electrolyte from corroding the core: lithium containing transition metal oxide can be readily corroded by HF in the electrolyte, while phosphate can hardly be corroded by HF. The coating layer can prevent HF from directly contacting the core, which will reduce dissolution of transition metals and improve the stability of the positive active material.

Compared with the prior art, the coating layer of the positive active material for use in a lithium ion battery according to the present invention can be stably bonded to the core and the coating layer has desirable lithium ion conductivity and structural stability. The positive active material according to the present invention has high capacity, desirable cycling performance, desirable safety performance, and high thermal stability. The positive active material according to the present invention also has a wider operating voltage range, having a voltage upper limit of 4.1V˜4.7V. The lithium ion battery having the positive active material according to the present invention has high volumetric energy density and desirable cycling performance.

According to one aspect of the present invention, the element represented by N′ is no less than the element represented by N, and the element represented by B is no less than the element represented by A.

According to one aspect of the present invention, the lithium containing transition metal oxide represented by LiₓM_{y}N_{1-y}O_{2-α}A_{β} is consisted of solid secondary particles or hollow secondary particles having an average particle size of 0.5 μm˜50 μm or preferably 2 μm˜15 μm. If the average particle size of the secondary particles is larger than 50 μm, the pressed density of the positive plate is reduced. If the average particle size of the secondary particles is less than 0.5 μm, the secondary particles will excessively contact the electrolyte due to large specific surface area, which may reduce the capacity and the cycling performance of the lithium ion battery.

According to one aspect of the present invention, each secondary particle is formed by primary particles having desirable crystallinity and an average particle size of 10 nm˜5 μm or preferably 300 nm˜2 μm bonded together. If the average particle size of the primary particles is less than 10 nm, the primary particles can be hardly gathered and sintered into secondary particles. If the average particle size of the primary particles is more than 5 μm, transmission path of lithium ions in the particles are too long, which may affect the dynamic performance of the lithium ion battery.

According to one aspect of the present invention, the lithium containing transition metal oxide represented by formula LiₓM_{y}N_{1-y}O_{2-α}A_{β} is consisted of primary particles, having an average particle size of 0.2 μm˜50 μm and preferably 0.5 μm˜35 μm.

According to one aspect of the present invention, the lithium containing transition metal oxide represented by formula LiₓM_{y}N_{1-y}O_{2-α}A_{β} is consisted of primary particles and secondary particles. The average particle size of the secondary particles is 0.5 μm˜50 μm, and preferably 2 μm˜15 μm. The average particle size of the primary particles is 0.2 μm˜35 μm, and preferably 0.5 μm˜8 μm.

According to one aspect of the present invention, the thickness of the coating layer of lithium containing transition metal phosphate represented by formula LiₐM_{b}N′_{1-b}PO_{4-λ}B_{ζ} is 0.1 nm˜500 nm, and preferably 1 nm˜300 nm The coating layer can conduct lithium ions and cannot conduct electronics. If the thickness of the coating layer is more than 500 nm, the electrons cannot pass through the coating layer. In this case, the positive active material is electively insulating material and does not have electrochemical activity. If the thickness of the coating layer is less than 0.1 nm, the coating layer cannot coat and protect the core.

According to one aspect of the present invention, a mass content of the lithium containing transition metal phosphate represented by formula LiₐM_{b}N′_{1-b}PO_{4-λ}B_{ζ} in the total positive active material is about 0.01%˜30%, and preferably 0.1%˜5.0%.

According to one embodiment of the present invention, a method for preparing a positive active material is provided. The method includes the steps of: preparing the core of lithium containing transition metal oxide represented by formula LiₓM_{y}N_{1-y}O_{2-α}A_{β}, adding P source; and obtaining the positive active material comprising the core of lithium containing transition metal oxide represented by formula LiₓM_{y}N_{1-y}O_{2-α}A_{β} and the coating layer of lithium containing transition metal phosphate represented by formula LiₐM_{b}N′_{1-b}PO_{4-λ}B_{ζ} in situ formed on the core via high temperature sintering.

According to one aspect of the present invention, the P source of the lithium containing transition metal phosphate represented by Formula LiₐM_{b}N′_{1-b}PO_{4-λ}B_{ζ} is at least one of elementary substance P, P₂O₃, P₂O₅, H₃PO₄, H₃PO₃, H₃PO₂, (NH₄)₃PO₄, (NH₄)₂ HPO₄, (NH₄)H₂ PO₄, (NH₄)₃PO₃, (NH₄)₃PO₂, Li₃PO₄, Li₂ HPO₄, LiH₂ PO₄, phosphate ester, phosphite ester, and a compound containing element P and at least two elements of Li, C, H, O, N, and preferably at least one of (NH₄)₃PO₄, P₂O₅, H₃PO₄.

According to one aspect of the present invention, the method includes the steps of:

1) preparing the core of lithium containing transition metal oxide represented by formula LiₓM_{y}N_{1-y}O_{2-α}A_{β}: preparing oxide, hydroxide or carbonate of transition metal via one of solid milling method, liquid coprecipitation method, sol-gel method, combustion method, solvothermal method, Pechini method; mixing oxide, hydroxide or carbonate of transition metal with lithium source, and sintering the mixture at 600˜1200° C. or preferably at 700-900° C.; or obtaining mixture containing lithium and transition metal via one of solid milling method, sol-gel method, combustion method, Pechini method; and sintering the mixture at 600˜1200° C. or preferably at 700˜900° C.;
2) adding P source into the core of lithium containing transition metal oxide represented by formula LiₓM_{y}N_{1-y}O_{2-α}A_{β}: uniformly dispersing the P source in the core represented by formula LiₓM_{y}N_{1-y}O_{2-α}A_{β} via one of solid milling method, sol-gel method, combustion method, Pechini method; and
3) solid phase sintering the mixture in step 2) at 400˜1200° C., or at 500˜900° C., and obtaining the positive active material comprising the core of lithium containing transition metal oxide represented by formula LiₓM_{y}N_{1-y}O_{2-α}A_{β} and the coating layer of lithium containing transition metal phosphate represented by formula LiₐM_{b}N′_{1-b}PO_{4-λ}B_{ζ} in situ formed on the core.

According to one aspect of the present invention, prior to step 3), at least one of NH₄VO₃, Nb₂O₅, ZrO₂, TiO₂, MoO₃, YNO₃ is added into the core, to obtain the coating layer of lithium containing transition metal phosphate represented by Formula LiₐM_{b}N′_{1-b}PO_{4-λ}B_{ζ} which has more element represented by N′ than element represented by N after solid phase sintering in step 3).

According to one aspect of the present invention, prior to step 3), at least one of NH₄F, LiF, HF, S, H₂S is added into the core, so as to obtain the coating layer of lithium containing transition metal phosphate represented by formula LiₐM_{b}N′_{1-b}PO_{4-λ}B_{ζ} which has more element represented by B than element represented by A after solid phase sintering in step 3).

According to one embodiment of the present invention, the method for preparing positive active material can in situ form coating layer of lithium containing transition metal phosphate represented by formula LiₐM_{b}N′_{1-b}PO_{4-λ}B_{ζ} on the core of lithium containing transition metal oxide represented by formula LiₓM_{y}N_{1-y}O_{2-α}A_{β}. The coating layer can be uniformly formed on the surface of the core. Compared with prior art coating method, the coating content of the coating layer of the positive active material according to the present invention can be controlled precisely. In addition, the method of the present invention is readily to be realized, readily to be carried out in industrial production, and can maintain the properties of the lithium containing transition metal oxides. The positive active material prepared according to the method of the present invention has high capacity, desirable cycling performance and desirable safety performance.

According to one embodiment of the present invention, a lithium ion battery is provided. The lithium ion battery includes a positive plate, a negative plate and a separator between the positive plate and the negative plate. The positive plate includes the positive active material as previously described.

According to one aspect of the present invention, the cut-off voltage of the lithium ion battery is 4.1-4.7V.

Examples of the present invention will now be described more fully hereinafter, in which some, but not all examples of the invention are shown. Indeed, the invention may be embodied in many different forms and should not be construed as limited to the examples as set forth herein; rather, these examples are provided so that this disclosure will satisfy applicable legal requirements.

### DETAILED DESCRIPTION OF VARIOUS EMBODIMENTS

### Example 1

The positive active material of Example 1 includes a core of Li_{1.09}Ni_{0.1}Co_{0.5}Mn_{0.4}O₂ obtained via coprecipitation method and 0.5 wt % of coating layer of Li_{1.09}Ni_{0.1}Co_{0.5}Mn_{0.4}PO₄ having a thickness of 100-200 nm The average particle size of the secondary particles of the core of Li_{1.09}Ni_{0.1}Co_{0.5}Mn_{0.4}O₂ is 18-20 μm and the average particle size of the primary particles of the core of Li_{1.09}Ni_{0.1}Co_{0.5}Mn_{0.4}O₂ is 0.7-1.0 μm.

The method for preparing the positive active material of Example 1 includes the steps of:

Dissolving NiSO₄, CoSO₄, MnSO₄ at an atom ratio of 0.1:0.5:0.4 in deionized water and obtaining a mixed solution of 1 mol/L; adding 1 mol/L NaOH solution in the mixed solution, fully stirring the mixed solution and maintaining the temperature at 75° C., and obtaining coprecipitate of loose ball shaped secondary particles having an average particles size of 20 μm-21 μm after full reaction; washing the coprecipitate with deionized water and ethanol repeatedly; sintering the washed coprecipitate in air at 500° C. for 5 hours; fully mixing the sintered coprecipitate with LiOH.H₂O and sintering the mixture of coprecipitate and LiOH.H₂O in air at 900° C. for 10 hours, and obtaining core of Li_{1.09}Ni_{0.1}Co_{0.5}Mn_{0.4}O₂ consisting of secondary particles arising from primary particles having a particle size of 700˜1000 nm

Mixing P₂O₅ with the core of Li_{1.09}Ni_{0.1}Co_{0.5}Mn_{0.4}O₂ at a mass ratio of 0.0025:1; milling the mixture of P₂O₅ and the core of Li_{1.09}Ni_{0.1}Co_{0.5}Mn_{0.4}O₂ in a planetary ball mill having a rotation speed of 300 r/min for 5 hours; sintering the fully milled mixture of P₂O₅ and the core of Li_{1.09}Ni_{0.1}Co_{0.5}Mn_{0.4}O₂ in air at 750° C. for 10 hours and obtaining a positive active material including a core of Li_{1.09}Ni_{0.1}Co_{0.5}Mn_{0.4}O₂ and a coating layer of Li_{1.09}Ni_{0.1}Co_{0.5}Mn_{0.4}PO₄.

### Example 2

The positive active material of Example 2 includes a core of Li_{1.10}Ni_{1/3}Co_{1/3}Mn_{1/3}O₂ obtained via coprecipitation method and 0.01 wt % of a coating layer of Li_{1.10}Ni_{1/3}Co_{1/3}Mn_{1/3}PO₄ having a thickness of 100-500 nm. The average particle size of the secondary particles of the core of Li_{1.10}Ni_{1/3}Co_{1/3}Mn_{1/3}O₂ is 48˜50 μm and the average particle size of the primary particles of the core of Li_{1.10}Ni_{1/3}Co_{1/3}Mn_{1/3}O₂ is 4.3-5.0 μm.

The method for preparing the positive active material of Example 2 includes the steps of:

Dissolving NiSO₄, CoSO₄, MnSO₄ at an atom ratio of 1.0:1.0:1.0 in deionized water and obtaining a mixed solution of 1 mol/L; adding 1 mol/L NaOH solution into the mixed solution, fully stirring the mixed solution and maintaining the temperature at 75° C., and obtaining coprecipitate of loose ball shaped secondary particles having an average particles size of 50 μm after full reaction; washing the coprecipitate with deionized water and ethanol repeatedly; sintering the washed coprecipitate in air at 500° C. for 5 hours; fully mixing the sintered coprecipitate with LiOH.H₂O and sintering the mixture of coprecipitate and LiOH.H₂O in air at 900° C. for 20 hours, and obtaining the core of Li_{1.10}Ni_{1/3}Co_{1/3}Mn_{1/3}O₂ consisting of secondary particles arising from primary particles having a particle size of 4.3˜5.0 μm.

Mixing (NH₄)₃PO₄ with the core of Li_{1.10}Ni_{1/3}Co_{1/3}Mn_{1/3}O₂ at a mass ratio of 0.0001:1; milling the mixture of (NH₄)₃PO₄ and the core of Li_{1.10}Ni_{1/3}Co_{1/3}Mn_{1/3}O₂ in a planetary ball mill having a rotation speed of 300 r/min for 5 hours; sintering the fully milled mixture in air at 550° C. for 10 hours and obtaining a positive active material including core of Li_{1.10}Ni_{1/3}Co_{1/3}Mn_{1/3}O₂ and a coating layer of Li_{1.10}Ni_{1/3}Co_{1/3}Mn_{1/3}PO₄.

### Example 3

The positive active material of Example 3 includes a core of Li_{1.08}Ni_{0.5}Co_{0.2}Mn_{0.3}O₂ obtained via combustion method and 20.0 wt % of coating layer of Li_{1.08}Ni_{0.5}Co_{0.2}Mn_{0.3}PO₄having a thickness of 50-80 nm The average particle size of the secondary particles of the core of Li_{1.08}Ni_{0.5}Co_{0.2}Mn_{0.3}O₂ is 0.5-0.8 μm and the average particle size of the primary particles of the core of Li_{1.08}Ni_{0.5}Co_{0.2}Mn_{0.3}O₂ is 0.01 μm.

The method for preparing the positive active material of Example 3 includes the steps of:

Dissolving lithium nitrate, nickel nitrate, cobalt nitrate, manganese nitrate at an atom ratio of 1.10:0.50:0.20:0.30 in ethanol in a container and obtaining a mixed solution; adding glycerol into the mixed solution after lithium nitrate, nickel nitrate, cobalt nitrate and manganese nitrate being fully dissolved, the ratio of glycerol to the total metal ions is 3:1; stirring the mixed solution in the contained in a water bath at 80° C. to evaporate the ethanol; moving the container to a resistance furnace and heating after the ethanol being fully evaporated, until the residue of the mixed solution fully combusting; collecting the combustion products and sintering the combustion products in air at 750° C. for 5 hours and obtaining the core of Li_{1.08}Ni_{0.5}Co_{0.2}Mn_{0.3}O₂ having an average particle size of 0.5-0.8 μm;

Dissolving H₃PO₄ and Li_{1.08}Ni_{0.5}Co_{0.2}Mn_{0.3}O₂ at a mass ratio of 0.12:1 in 500 mL deionized water in a container and obtaining a mixed solution; after 1˜1₃PO₄ and Li_{1.08}Ni_{0.5}Co_{0.2}Mn_{0.3}O₂ being fully dissolved; moving the container having the mixed solution to a water bath at 80° C. and stirring to evaporate the water; moving the container into an oven at 160° C. for 5 hours and obtaining black powder; sintering the black powder in air at 650° C. for 10 hours, and obtaining a positive active material including a core of Li_{1.08}Ni_{0.5}Co_{0.2}Mn_{0.3}O₂ and a coating layer of Li_{1.08}Ni_{0.5}Co_{0.2}Mn_{0.3}PO₄.

### Example 4

The positive active material of Example 4 includes a core of Li_{1.20}Ni_{0.5}Co_{0.2}Mn_{0.29}Zr_{0.01}O_{1.98}F_{0.04} obtained via sol gel method and 3.0 wt % of coating layer of Li_{1.05}Ni_{0.5}Co_{0.2}Mn_{0.29}Zr_{0.01}PO_{3.98}F_{0.04} having a thickness of 100-200 nm. The average particle size of the secondary particles of the core of Li_{1.20}Ni_{0.5}Co_{0.2}Mn_{0.29}Zr_{0.01}O_{1.98}F_{0.04} is 3.5-6.5 μm and the average particle size of the primary particles of the core of Li_{1.20}Ni_{0.5}Co_{0.2}Mn_{0.29}Zr_{0.01}O_{1.98}F_{0.04} is 0.4 μm.

The method for preparing the positive active material of Example 4 includes the steps of:

Dissolving lithium acetate, nickel acetate, cobalt acetate, manganese acetate, nano titanium dioxide, ammonium fluoride at an atom ratio of 1.23:0.50:0.20:0.29:0.01: 0.04 in deionized water in a container and obtaining a mixed solution; adding citric acid into the mixed solution after lithium acetate, nickel acetate, cobalt acetate, manganese acetate, nano titanium dioxide, ammonium fluoride being fully dissolved, the ratio of citric acid to the total metal ions is 2:1; stirring the mixed solution in the container in a water bath at 85° C. to evaporate the water and obtaining gelatinous substance; moving the container to an oven at a 160° C. and heating for 5 hours, and obtaining brown-black substance; milling the brown-black substance into powder, sintering the powder in air at 750° C. for 25 hours and obtaining the core of Li_{1.20}Ni_{0.5}Co_{0.2}Mn_{0.29}Zr_{0.01}O_{1.98}F_{0.04} having an average particle size of 3.5-6.5 μm;

Dissolving (NH₄)₃PO₄ and Li_{1.20}Ni_{0.5}Co_{0.2}Mn_{0.29}Zr_{0.01}O_{1.98}F_{0.04} at a mass ratio of 0.0268:1 in 500 mL deionized water in a container and obtaining a mixed solution; setting the container having the mixed solution in a water bath at 80° C. and stirring to evaporate the water; placing the container in an oven at 160° C. for 5 hours and obtaining black powder; sintering the black powder in air at 850° C. for 10 hours, and obtaining a positive active material including a core of Li_{1.20}Ni_{0.5}Co_{0.2}Mn_{0.29}Zr_{0.01}O_{1.98}F_{0.04} and a coating layer of Li_{1.05}Ni_{0.5}Co_{0.2}Mn_{0.29}Zr_{0.01}PO_{3.98}F_{0.04}.

### Example 5

The positive active material of Example 5 includes a core of Li_{0.98}Ni_{0.6}Co_{0.18}Mn_{0.2}Ti_{0.02}O₂ obtained via coprecipitation method and 0.40 wt % of coating layer of Li_{0.98}Ni_{0.6}Co_{0.18}Mn_{0.2}Ti_{0.02}PO₄ having a thickness of 10-5 nm The average particle size of the secondary particles of the core of Li_{0.98}Ni_{0.6}Co_{0.18}Mn_{0.2}Ti_{0.02}O₂ is 8.0-12.0 μm and the average particle size of the primary particles of the core of Li_{0.98}Ni_{0.6}Co_{0.18}Mn_{0.2}Ti_{0.02}O₂ is 0.5-0.7 μm.

The method for preparing the positive active material of Example 5 includes the steps of:

Dissolving NiSO₄, CoSO₄, MnSO₄, nano TiO₂ at an atom ratio of 0.60:0.18: 0.20:0.02 in deionized water and obtaining a mixed solution of 1 mol/L; adding 1 mol/L NaOH solution into the mixed solution, fully stirring the mixed solution and maintaining the temperature at 75° C. ; obtaining coprecipitate of loose ball shaped secondary particles having an average particles size of 8.0-12.0 μm after full reaction; washing the coprecipitate with deionized water and ethanol repeatedly; sintering the washed coprecipitate in air at 500° C. for 5 hours; fully mixing the sintered coprecipitate with Li₂CO₃ and sintering the mixture of the sintered coprecipitate and Li₂CO₃ in air at 750° C. for 10 hours, and obtaining a core of Li_{0.98}Co_{0.18}Mn_{0.2}Ti_{0.02}O₂.

Mixing P₂O₅ with the core of Li_{0.98}Co_{0.18}Mn_{0.2}Ti_{0.02}O₂ at a mass ratio of 0.002:1; milling the mixture of P₂O₅ and the core of Li_{0.98}Co_{0.18}Mn_{0.2}Ti_{0.02}O₂ in a planetary ball mill having a rotation speed of 500 r/min for 5 hours; sintering the fully milled mixture in air at 900° C. for 2 hours and obtaining a positive active material including a core of Li_{0.98}Co_{0.18}Mn_{0.2}Ti_{0.02}O₂ and a coating layer of Li_{0.98}Co_{0.18}Mn_{0.2}Ti_{0.02}PO₄.

### Example 6

The positive active material of Example 6 includes a core of Li_{0.9}Ni_{0.75}Co_{0.15}Mn_{0.1}O₂ obtained via Pechini method and 0.35 wt % of coating layer of Li_{0.9}Ni_{0.75}Co_{0.15}Mn_{0.1}PO₄ having a thickness of 15-20 nm The average particle size of the secondary particles of the core of Li_{0.9}Ni_{0.75}Co_{0.15}Mn_{0.1}O₂ is 7.0-10.0 μm and the average particle size of the primary particles of the core of Li_{0.9}Ni_{0.75}Co_{0.15}Mn_{0.1}O₂ is 0.7-0.9 μm.

The method for preparing the positive active material of Example 6 includes the steps of:

Dissolving LiNO₃, NiNO₃, CoNO₃, MnNO₃ at an atom ratio of 0.92:0.75:0.15: 0.10 in deionized water in a container and obtaining a metal ion solution having a metal ion concentration of 1 mol/L; dissolving citric acid in polyethylene glycol and obtaining a citric acid solution of 1.5 mol/L; mixing the metal ion solution and the citric acid solution at a ratio of 2:1, and heating the container having the mixture of the metal ion solution and the citric acid solution in an oil bath at 130° C. until the mixture in the container turning into black sticky substance; moving the container into a Muffle furnace and prefiring at 300° C. for 5 hours; milling the prefired products into powder, sintering the powder in air at 800° C. for 10 hours, and obtaining a core of Li_{0.9}Ni_{0.75}Co_{0.15}Mn_{0.1}O₂.

Mixing P₂O₅ with the core of Li_{0.9}Ni_{0.75}Co_{0.15}Mn_{0.1}O₂ at a mass ratio of 0.0023:1; milling the mixture of P₂O₅ and the core of Li_{0.9}Ni_{0.75}Co_{0.15}Mn_{0.1}O₂ in a planetary ball mill having a rotation speed of 500 r/min for 5 hours; sintering the fully milled mixture in air at 600° C. for 2 hours and obtaining a positive active material including a core of Li_{0.9}Ni_{0.75}Co_{0.15}Mn_{0.1}O₂ and a coating layer of Li_{0.9}Ni₀₇₅Co₀₁₅Mn_{0.1}PO₄.

### Example 7

The positive active material of Example 7 includes a core of Li_{1.03}Ni_{0.8}Co_{0.1}Mn_{0.1}O₂ obtained via coprecipitation method and 0.50 wt % of coating layer of Li_{1.03}Ni_{0.72}Co_{0.09}Mn_{0.09}V_{0.1}PO₄ having a thickness of 40-50 nm The average particle size of the secondary particles of the core of Li_{1.03}Ni_{0.8}Co_{0.1}Mn_{0.1}O₂ is 12.0-15.0 μm and the average particle size of the primary particles of the core of Li_{1.03}Ni_{0.8}Co_{0.1}Mn_{0.1}O₂ is 1.5-2.0 μm.

The method for preparing the positive active material of Example 7 includes the steps of:

Dissolving NiSO₄, CoSO₄, MnSO₄ at an atom ratio of 0.80:0.10:0.10 in deionized water and obtaining a mixed solution of 1 mol/L; adding 1 mol/L NaOH solution into the mixed solution, stirring the mixed solution and maintaining the temperature at 75° C.; obtaining coprecipitate of loose ball shaped secondary particles having an average particles size of 12.5-15.5 μm after full reaction; washing the coprecipitate with deionized water and ethanol repeatedly; sintering the washed coprecipitate in air at 500° C. for 5 hours; fully mixing the sintered coprecipitate with LiOH.H₂O and sintering the mixture of the coprecipitate and LiOH.H₂O in air at 900° C. for 20 hours, and obtaining a core of Li_{1.03}Ni_{0.8}Co_{0.1}Mn_{0.1}O₂.

Milling (NH₄)₃PO₄, NH₄VO₃ and the core of Li_{1.03}Ni_{0.8}Co_{0.1}Mn_{0.1}O₂ at a mass ratio of 0.0045:0.0004:1 in a planetary ball mill having a rotation speed of 300 r/min for 5 hours; sintering the fully milled mixture of (NH₄)₃PO₄, NH₄VO₃ and the core of Li_{1.03}Ni_{0.8}Co_{0.1}Mn_{0.1}O₂ in air at 750° C. for 10 hours and obtaining a positive active material including a core of Li_{1.03}Ni_{0.8}Co_{0.1}Mn_{0.1}O₂ and a coating layer of Li_{1.03}Ni_{0.72}Co_{0.09}Mn_{0.09}V_{0.1}PO₄.

### Example 8

The positive active material of Example 8 includes a core of Li_{1.07}Ni_{0.82}Co_{0.10}Mn_{0.07}Zr_{0.004}Mg_{0.002}Ti_{0.004}O₂ obtained via coprecipitation method and 0.25 wt % of coating layer of Li_{1.07}Ni_{0.82}Co_{0.10}Mn_{0.07}Zr_{0.004}Mg_{0.002}Ti_{0.004}PO₄ having a thickness of 12-15 nm The average particle size of the secondary particles of the core of Li_{1.07}Ni_{0.82}Co_{0.10}Mn_{0.07}Zr_{0.004}Mg_{0.002}Ti_{0.004}O₂ is 15.0-18.0 μm and the average particle size of the primary particles of the core of Li_{1.07}Ni_{0.82}Co_{0.10}Mn_{0.07}Zr_{0.004}Mg_{0.002}Ti_{0.004}O₂ is 0.8-1.0 μm.

The method for preparing the positive active material of Example 8 includes the steps of:

Dissolving NiSO₄, CoSO₄, MnSO₄ at an atom ratio of 0.82:0.10:0.07 in deionized water and obtaining a mixed solution having a concentration of 1 mol/L; adding 1 mol/L NaOH solution into the mixed solution and stirring, and maintaining the temperature at 75° C.; obtaining coprecipitate of loose ball shaped secondary particles having an average particles size of 15.0-18.0 μm after full reaction; washing the coprecipitate with deionized water and ethanol repeatedly; mixing the washed red coprecipitate Li₂CO₃, nano ZrO₂, nano MgO, nanoTiO₂ in an inclined mixer having a rotation speed of 50 r/min for 5 hours; sintering the mixture of the washed red coprecipitate, Li₂CO₃, nano ZrO₂, nano MgO and nanoTiO₂ in air at 800° C. for 5 hours, and obtaining a core of Li_{1.07}Ni_{0.82}Co_{0.10}Mn_{0.07}Zr_{0.004}Mg_{0.002}Ti_{0.004}O₂.

Dissolving (NH₄)₃PO₄ and Li_{1.07}Ni_{0.82}Co_{0.10}Mn_{0.07}Zr_{0.004}Mg_{0.002}Ti_{0.004}O₂ at a mass ratio of 0.0026:1 in 500 mL deionized water in a container and obtaining a mixed solution after fully dissolution; adding 1 mol citric acid into the mixed solution, setting the container having the mixed solution in a water bath at 90° C. and stirring so as to evaporate the water; placing the container in an oven at 160° C. for 5 hours and obtaining black powder; sintering the black powder in air at 650° C. for 5 hours, and obtaining a positive active material including core of Li_{1.07}Ni_{0.82}Co_{0.10}Mn_{0.07}Zr_{0.004}Mg_{0.002}Ti_{0.004}O₂ and a coating layer of Li_{1.07}Ni_{0.82}Co_{0.10}Mn_{0.07}Zr_{0.004}Mg_{0.002}Ti_{0.004}PO₄.

### Example 9

The positive active material of Example 9 includes a core of Li_{0.95}Ni_{0.9}Co_{0.05}Mn_{0.04}Mg_{0.01}O₂ obtained via coprecipitation method and 0.15 wt % of coating layer of Li_{1.00}Ni_{0.9}Co_{0.05}Mn_{0.04}M_{0.01}PO₄ having a thickness of 8-10 nm The average particle size of the secondary particles of the core of Li_{0.95}Ni_{0.9}Co_{0.05}Mn_{0.04}Mg_{0.01}O₂ is 10.0-12.0 μm and the average particle size of the primary particles of the core of Li_{0.95}Ni_{0.9}Co_{0.05}Mn_{0.04}Mg_{0.01}O₂ is 0.7-0.8 μm.

The method for preparing the positive active material of Example 9 includes the steps of:

Dissolving NiSO₄, CoSO₄, MnSO₄ at an atom ratio of 0.9:0.05:0.04 in deionized water and obtaining a mixed solution having a concentration of 1 mol/L; adding 1 mol/L NaOH solution into the mixed solution and stirring, while maintaining the temperature at 70° C.; obtaining coprecipitate of loose ball shaped secondary particles having an average particles size of 8.0-10.0 μm after full reaction; washing the coprecipitate with deionized water and ethanol repeatedly; mixing the coprecipitate with nano MgO in an inclined mixer having a rotation speed of 50 r/min for 5 hours; mixing the mixture of the coprecipitate and nano MgO with LiOH.H₂O, sintering the mixture in air at 800° C. for 10 hours, and obtaining a core of Li_{0.95}Ni_{0.9}Co_{0.05}Mn_{0.04}Mg_{0.01}O₂.

Mixing H₃PO₄ with the core of Li_{0.95}Ni_{0.9}Co_{0.05}Mn_{0.04}Mg_{0.01}O₂ at a mass ratio of 0.0011:1; milling the mixture of the core of Li_{0.95}Ni_{0.9}Co_{0.05}Mn_{0.04}Mg_{0.01}O₂ and H₃PO₄ in a planetary ball mill having a rotation speed of 500 r/min for 5 hours; sintering the milled mixture of H₃PO₄ and the core of Li_{0.95}Ni_{0.9}Co_{0.05}Mn_{0.04}Mg_{0.01}O₂ in air at 600° C. for 2 hours and obtaining a positive active material including core of Li_{0.95} Ni_{0.9}Co_{0.05} Mn_{0.04}Mg_{0.01}O₂ and a coating layer of Li_{1.00}Ni_{0.9}Co_{0.05}Mn_{0.04}Mg_{0.01}PO₄.

### Example 10

The positive active material of Example 10 includes a core of Li_{1.08}Ni_{1/3}Co_{1/3}Mn_{1/3}O₂ obtained via solid milling method and 17.0 wt % of coating layer of Li_{1.08}Ni_{1/3}Co_{1/3}Mn_{1/3}PO₄ having a thickness of 20-50 nm The core of Li_{1.08}Ni_{1/3}Co_{1/3}Mn_{1/3}O₂ is consisted of primary particles and has an average particle size of 0.2-0.4 μm.

The method for preparing the positive active material of Example 10 includes the steps of:

Mixing Li₂CO₃, nickel oxalate, cobalt oxalate, MnCO₃ at a molar ratio of 0.56:1.0:1.0:1.0 in a zirconia sander having a rotation speed of 1000 r/min for 5 hours, diameter of zirconia milling media is 3 mm, and the ratio of zirconia milling media to the mixture of Li₂CO₃, nickel oxalate, cobalt oxalate, MnCO₃ is 1:1; removing the zirconia milling media and sintering the remained mixture in air at 750° C. for 5 hours and obtaining the core of Li_{1.08}Ni_{1/3}Co_{1/3}Mn_{1/3}O₂.

Dissolving H₃PO₄ and the core of Li_{1.08}Ni_{1/3}Co_{1/3}Mn_{1/3}O₂ at a mass ratio of 0.1030:1 in 500mL deionized water in a container and obtaining a mixed solution after H₃PO₄ and the core of Li_{1.08}Ni_{1/3}Co_{1/3}Mn_{1/3}O₂ being fully dissolved; setting the container having the mixed solution in a water bath at 90° C. and stirring so as to evaporate the water; placing the container in an oven at 180° C. for 5 hours and obtaining black powder; sintering the black powder in air at 850° C. for 6 hours, obtaining a positive active material including a core of Li_{1.08}Ni_{1/3}Co_{1/3}Mn_{1/3}O₂ and a coating layer of Li_{1.08}Ni_{1/3}Co_{1/3}Mn_{1/3}PO₄.

### Example 11

The positive active material of Example 11 includes a core of Li_{1.05}Ni_{0.5}Co_{0.2}Mn_{0.28}Zr_{0.02}O_{1.98}F_{0.04} obtained via coprecipitation and solid milling method and 2.0 wt % of coating layer of Li_{1.05}Ni_{0.5}Co_{0.2}Mn_{0.28}Zr_{0.02}PO_{3.98}F_{0.04} having a thickness of 180-200 nm The core of Li_{1.05}Ni_{0.5}Co_{0.2}Mn_{0.28}Zr_{0.02}O_{1.98}F_{0.04} is consisted of primary particles and has an average particle size of 32.0-35.0 μm.

The method for preparing the positive active material of Example 11 includes the steps of:

Dissolving NiSO₄, CoSO₄, MnSO₄ at an atom ratio of 0.50:0.20:0.28 in deionized water and obtaining a mixed solution having a concentration of 1 mol/L; adding 1 mol/L NaOH solution into the mixed solution and stirring, while maintaining the temperature at 70° C.; obtaining coprecipitate of loose ball shaped secondary particles having an average particles size of 8.0-10.0 μm after full reaction; washing the coprecipitate with deionized water and ethanol repeatedly; mixing the washed coprecipitate with LiOH.H₂O, nano ZrO₂ and NH₄F in a zirconia sander having a rotation speed of 800 r/min and mixing for 5 hours, the diameter of the zirconia milling media is 3 mm, and the ratio of the zirconia milling media to the mixture of the washed coprecipitate with LiOH H₂O, nano ZrO₂ and NH₄F is 1:1; removing the zirconia milling media and sintering the remained mixture in air at 950° C. for 24 hours and obtaining a core of Li_{1.05}Ni_{0.5}Co_{0.2}Mn_{0.28}Zr_{0.02}O_{1.98}F_{0.04}.

Mixing (NH₄)₂ HPO₄ with the core of Li_{1.05}Ni_{0.5}Co_{0.2}Mn_{0.28}Zr_{0.02}O_{1.98}F_{0.04} at a mass ratio of 0.0200:1; milling the mixture of (NH₄)₂ HPO₄ and the core of Li_{1.05}Ni_{0.5}Co_{0.2}Mn_{0.28}Zr_{0.02}O_{1.98}F_{0.04} in an inclined mixer having a rotation speed of 50 r/min for 10 hours; sintering the fully milled mixture in air at 750° C. for 6 hours and obtaining a positive active material having a core of Li_{1.05}Ni_{0.5}Co_{0.2}Mn_{0.28}Zr_{0.02}O_{1.98}F_{0.04} and a coating layer of Li_{1.05}Ni_{0.5}Co_{0.2}Mn_{0.28}Zr_{0.02}PO_{3.98}F_{0.04}.

### Example 12

The positive active material of Example 12 includes core material Li_{1.05}Ni_{0.5}Co_{0.2}Mn_{0.28}Zr_{0.02}O_{1.98}F_{0.04} obtained via sol-gel method and 2.0 wt % coating layer of Li_{1.05}Ni_{0.5}Co_{0.2}Mn_{0.28}Zr_{0.02}PO_{3.98}F_{0.04} having a thickness of 8-10 nm The average particle size of the primary particles of core material Li_{1.05}Ni_{0.5}Co_{0.2}Mn_{0.28}Zr_{0.02}PO_{3.98}F_{0.04} is 0.4 μm.

The method for preparing the positive active material of Example 12 includes the steps of:

Dissolving lithium acetate, nickel acetate, cobalt acetate, manganese acetate, nano titanium dioxide, ammonium fluoride at an atom ratio of 1.07:0.50:0.20: 0.28:0.02:0.04 in deionized water in a container and obtaining a mixed solution; adding citric acid into the mixed solution after lithium acetate, nickel acetate, cobalt acetate, manganese acetate, nano titanium dioxide, ammonium fluoride being fully dissolved, the ratio of citric acid to the total metal ions is 2:1; stirring the mixed solution in the container in a water bath at 85° C., to evaporate the water and obtain gelatinous substance;

placing the container in an oven at 160° C. for 5 hours, and obtaining brown-black substance; milling the brown-black substance in a zirconia sander having a rotation speed of 800 r/min for 5 hours, diameter of the zirconia milling media is 2 mm, and the ratio of the zirconia milling media to the brown-black substance is 1:1; removing the zirconia milling media and sintering the remaining brown-black substance in air at 750° C. for 5 hours and obtaining a core of Li_{1.05}Ni_{0.5}Co_{0.2}Mn_{0.28}Zr_{0.02}O_{1.98}F_{0.04}.

Dissolving 2-ethylhexyl phosphonic acid mono-2-ethylhexyl ester and the core of Li_{1.05}Ni_{0.5}Co_{0.2}Mn_{0.28}Zr_{0.02}O_{1.98}F_{0.04} at a mass ratio of 0.0480:1 in 500mL deionized water in a container and obtaining a mixed solution; setting the container having the mixed solution in a 600 L PTFE sealing container and placing and sealing the container in a stainless steel housing; placing the container in an oven at 135° C. for 5 hours and obtaining black powder; sintering the black powder in air at 550° C. for 10 hours, obtaining a positive active material having a core of Li_{1.05}Ni_{0.5}Co_{0.2}Mn_{0.28}Zr_{0.02}O_{1.98}F_{0.04} and a coating layer of Li_{1.05}Ni_{0.5}Co_{0.2}Mn_{0.28}Zr_{0.02}PO_{3.98}F_{0.04}.

### Example 13

The positive active material of Example 13 includes a core of Li_{1.03}Ni_{0.8}Co_{0.1}Mn_{0.1}O₂ obtained via solid milling method and 7.0 wt % of coating layer of Li_{1.03}Ni_{0.72}Co_{0.09}Mn_{0.09}V_{0.1}PO₄ having a thickness of 20-30 nm The core of Li_{1.03}Ni_{0.8}Co_{0.1}Mn_{0.1}O₂ is consisted of primary particles and has an average particle size of 5.0-7.0 μm.

The method for preparing the positive active material of Example 13 includes the steps of:

Milling Li₂CO₃, nickel oxalate, cobalt oxalate, MnCO₃ at a molar ratio of 0.53:0.8:0.1:0.1 in a zirconia sander having a rotation speed of 1000 r/min for 5 hours, the diameter of zirconia milling media is 5mm, and the ratio of the zirconia milling media to the mixture of Li₂CO₃, nickel oxalate, cobalt oxalate, MnCO₃ is 1:2; removing the zirconia milling media and sintering the remaining mixture in air at 900° C. for 5 hours and obtaining a core of Li_{1.03}Ni_{0.8}Co_{0.1}Mn_{0.1}O₂.

Placing the core of Li_{1.03}Ni_{0.8}Co_{0.1}Mn_{0.1}O₂ in a tube furnace; adopting nitrogen with a flow rate of 1 L/min as carrier gas; introducing carbon disulfide solution having 0.2 mol/L elementary substance P dissolved therein into the tube furnace, to deposite elementary substance P on a surface of the core of Li_{1.03}Ni_{0.8}Co_{0.1}Mn_{0.1}O₂; sintering the core of Li_{1.03}Ni_{0.8}Co_{0.1}Mn_{0.1}O₂ having elementary substance P deposited thereon in air at 700° C. for 5 hours, and obtaining a positive active material including a core of Li_{1.03}Ni_{0.8}Co_{0.1}Mn_{0.1}O₂ and a coating layer of Li_{1.03}Ni_{0.72}Co_{0.09}Mn_{0.09}PO₄.

### Example 14

The positive active material of Example 14 includes a core of Li_{1.08}Ni_{1/3}Co_{1/3}Mn_{1/3}O₂ obtained via coprecipitation method and 0.10 wt % of coating layer of Li_{1.08}Ni_{1/3}Co_{1/3}Mn_{1/3}PO₄ having a thickness of 200-300 nm The average particle size of the secondary particles of the core of Li_{1.08}Ni_{1/3}Co_{1/3}Mn_{1/3}O₂ is 4.0-7.0 μm and the average particle size of the primary particles of the core of Li_{1.08}Ni_{1/3}Co_{1/3}Mn_{1/3}O₂ is 0.6-0.7 μm.

The method for preparing the positive active material of Example 14 includes the steps of:

Dissolving NiSO₄, CoSO₄, MnSO₄ at an atom ratio of 1.0:1.0:1.0 in deionized water and obtaining a mixed solution having a concentration of 1 mol/L; adding 1 mol/L NaOH solution into the mixed solution and stirring, as well as maintaining the temperature at 75° C.; obtaining coprecipitate of loose ball shaped secondary particles having an average particles size of 4.0-7.0 μm after full reaction; washing the coprecipitate with deionized water and ethanol repeatedly; sintering the washed coprecipitate in air at 500° C. for 5 hours and obtaining secondary particles of oxide or hydroxide A; milling nickel oxalate, cobalt oxalate, MnCO₃ at a molar ratio of 1.0:1.0:1.0 in a zirconia sander having a rotation speed of 1000 r/min for 5 hours, diameter of the zirconia milling media is 5 mm, and the ratio of zirconia milling media to the mixture of nickel oxalate, cobalt oxalate, MnCO₃ is 1:1; removing the zirconia milling media and sintering the remaining mixture in air at 700° C. for 5 hours and obtaining oxide or hydroxide or carbonate B of the primary particles; mixing A and B, and mixing the mixture of A and B with LiOH.H₂O and sintering the mixture in air at 800° C. for 5 hours, and obtaining a core of Li_{1.08}Ni_{1/3}Co_{1/3}Mn_{1/3}O₂.

Sintering the mixture of P₂O₅ and the core of Li_{1.08}Ni_{1/3}Co_{1/3}Mn_{1/3}O₂ at a mass ratio of 0.0005:1 in air at 700° C. for 10 hours and obtaining a positive active material including the core of Li_{1.08}Ni_{1/3}Co_{1/3}Mn_{1/3}O₂ and a coating layer of Li_{1.08}Ni_{1/3}Co_{1/3}Mn_{1/3}PO₄.

### Example 15

The positive active material of Example 15 includes a core of Li_{1.03}Ni_{0.8}Co_{0.1}Mn_{0.1}O₂ obtained via coprecipitation method and 0.5 wt % of coating layer of Li_{1.03}Ni_{0.8}Co_{0.1}Mn_{0.1}PO₄ having a thickness of 15-20 nm The average particle size of the secondary particles of the core of Li_{1.03}Ni_{0.8}Co_{0.1}Mn_{0.1}O₂ is 7.0-8.0 μm and the average particle size of the primary particles of the core of Li_{1.03}Ni_{0.8}Co_{0.1}Mn_{0.1}O₂ is 0.6 μm.

The method for preparing the positive active material of Example 15 includes the steps of:

Dissolving NiSO₄, CoSO₄, MnSO₄ at an atom ratio of 0.80:0.10:0.10 in deionized water and obtaining a mixed solution having a concentration of 1 mol/L; adding 1 mol/L NaOH solution into the mixed solution and stirring, as well as maintaining the temperature at 70° C.; obtaining coprecipitate of loose ball shaped secondary particles having an average particles size of 7.5-9.0 μm after full reaction; washing the coprecipitate with deionized water and ethanol repeatedly; fully mixing the washed coprecipitate with LiOH.H₂O and sintering the mixture of the coprecipitate and LiOH.H₂O in air at 850° C. for 10 hours, and obtaining a core of Li_{1.03}Ni_{0.8}Co_{0.1}Mn_{0.1}O₂.

Mixing and milling H₃PO₄ with the core of Li_{1.03}Ni_{0.8}Co_{0.1}Mn_{0.1}O₂ at a mass ratio of 0.0034:1 in an inclined mixer having a rotation speed of 30 r/min for 10 hours; sintering the fully milled mixture in air at 850° C. for 6 hours and obtaining a positive active material including a core of Li_{1.03}Ni_{0.8}Co_{0.1}Mn_{0.1}O₂ and a coating layer of Li_{1.03}Ni_{0.8}Co_{0.1}Mn_{0.1}PO₄.

### Example 16

The positive active material of Example 16 includes a core of Li_{1.04}Ni_{0.8}Co_{0.1}Mn_{0.1}O₂ obtained via coprecipitation method and 0.7 wt % of coating layer of Li_{1.04}Ni_{0.8}Co_{0.1}Mn_{0.1}PO₄ having a thickness of 15-20 nm. The average particle size of the secondary particles of the core of Li_{1.04}Ni_{0.8}Co_{0.1}Mn_{0.1}O₂ is 6.5-7.5 μm and the average particle size of the primary particles of the core of Li_{1.04}Ni_{0.8}Co_{0.1}Mn_{0.1}O₂ is 0.8 μm.

The method for preparing the positive active material of Example 16 includes the steps of:

Dissolving NiSO₄, CoSO₄, MnSO₄ at an atom ratio of 0.8:0.1:0.1 in deionized water and obtaining a mixed solution having a concentration of 1 mol/L; adding 1 mol/L NaOH solution into the mixed solution and stirring, and maintaining the temperature at 70° C.; obtaining coprecipitate of loose ball shaped secondary particles having an average particles size of 6.5-8.0 μm after full reaction; washing the coprecipitate with deionized water and ethanol repatedly; sintering the washed coprecipitate in air at 850° C. for 10 hours; fully mixing the sintered coprecipitate with LiOH.H₂O and sintering the mixture of the coprecipitate and LiOH.H₂O in air at 850° C. for 10 hours, and obtaining a core of Li_{1.04}Ni_{0.8}Co_{0.1}Mn_{0.1}O₂.

Mixing and milling H₃PO₄ with the core of Li_{1.04}Ni_{0.8}Co_{0.1}Mn_{0.1}O₂ at a mass ratio of 0.0060:1 in a planetary ball mill having a rotation speed of 500 r/min for 5 hours; sintering the fully milled mixture in air at 500° C. for 2 hours and obtaining a positive active material including a core of Li_{1.04}Ni_{0.8}Co_{0.1}Mn_{0.1}O₂ and a coating layer of Li_{1.04}Ni_{0.8}Co_{0.1}Mn_{0.1} PO₄.

### Example 17

The positive active material of Example 17 includes a core of Li_{1.05}CoO₂ obtained via coprecipitation method and 0.01 wt % of coating layer of Li_{1.05}CoPO₄ having a thickness of 50˜100 nm The average particle size of the secondary particles of the core of Li_{1.05}CoO₂ is 35˜40 μm and the average particle size of the primary particles of the core of Li_{1.05}CoO₂ is 1.2˜2.0 μm.

The method for preparing the positive active material of Example 17 includes the steps of:

Preparing 1 mol/L CoSO₄ solution; slowly dripping 1 mol/L NH₄HCO₃ solution with a dripping rate of 1 L/h in the CoSO₄ solution; after coprecipitation, filtering and washing the coprecipitate with deionized water, and obtaining CoCO₃ after drying; mixing Li₂CO₃ and CoCO₃ at a molar ratio of 1.07:1 in a planetary ball mill having a rotation speed of 200 r/min for 5 hours; sintering the fully mixed mixture of Li₂CO₃ and CoCO₃ in air at 900° C. for 10 hours; adding H₃PO₄ and the sintered product in a container having 500 mL deionized water; heating the container in a water bath at 75° C. and stirring to evaporate the water; placing the container in an oven at 180° C. for heating 5 hours, and obtaining black powder; sintering the black powder in air at 650° C. for 6 hours, and obtaining a positive active material including a core of Li_{1.05}CoO₂ and a coating layer of Li_{1.05}CoPO₄.

### Example 18

The positive active material of Example 18 includes a core of Li_{1.01}Co_{0.89}Mg_{0.05}Al_{0.04}Ti_{0.02}O₂ obtained via sol-gel method and 0.4 wt % of coating layer of Li_{1.01}Co_{0.89}Mg_{0.05}Al_{0.04}Ti_{0.02}PO₄ having a thickness of 15˜20 nm The core of Li_{1.01}Co_{0.89}Mg_{0.05}Al_{0.04}Ti_{0.02}O₂ is consisted of monocrystalline particles and has an average particle size of 8.0˜12.0 μm.

The method for preparing the positive active material of Example 18 includes the steps of:

Dissolving lithium acetate, cobalt acetate, nano magnesia, nano alumina and nano titanium dioxide at an atom ratio of 1.03:0.89:0.05:0.04:0.02 in deionized water in a container and obtaining a mixed solution; adding citric acid into the mixed solution after lithium acetate, cobalt acetate, nano magnesia, nano alumina and nano titanium dioxide being fully dissolved, the ratio of citric acid to the total metal ions is 2:1; stirring the mixed solution in the container in a water bath at 85° C., to evaporate the water and obtain gelatinous substance; placing the container in an oven at 160° C. for 5 hours, and obtaining brown-black substance; milling the brown-black substance into powder, sintering the powder in air at 900° C. for 24 hours and obtaining a core of Li_{1.01}Co_{0.89}Mg_{0.05}Al_{0.04}Ti_{0.02}O₂ consisting of primary particles having an average particle size of 8.0-12.0 μm;

Dispersing the core of Li_{1.01}Co_{0.89}Mg_{0.05}Al_{0.04}Ti_{0.02}O₂ in 0.2% phosphoric acid solution at a concentration of 500 gL and obtaining a mixed solution; placing the mixed solution in water bath of 85° C., to evaporate the water and obtain gelatinous substance; sintering the gelatinous substance in air at 750° C. for 5 hours, and obtaining a positive active material including a core of Li_{1.01}Co_{0.89}Mg_{0.05}Al_{0.04}Ti_{0.02}O₂ and a coating layer of Li_{1.01}Co_{0.89}Mg_{0.05}Al_{0.04}Ti_{0.02}PO₄.

### Example 19

The positive active material of Example 19 includes a core of monocrystalline Li_{0.98}Co_{0.6}Al_{0.38}Ti_{0.02}O₂ obtained via coprecipitation method and 2.00 wt % of coating layer of Li_{0.98}Co_{0.6}Al_{0.38}Ti_{0.02}PO₄ having a thickness of 100˜150 nm The average particle size of the monocrystalline core of Li_{0.98}Co_{0.6}Al_{0.38}Ti_{0.02}O₂ is 15˜20 μm.

The method for preparing the positive active material of Example 19 includes the steps of:

Preparing 1 mol/L CoSO₄ solution; slowly dripping 1 mol/L NH₄HCO₃ solution with a dripping rate of 1 L/h into the CoSO₄ solution; after coprecipitation, filtering and washing the coprecipitate with deionized water, and obtaining CoCO₃ after drying; mixing Li₂CO₃, CoCO₃, nano Al₂O₃ and nano TiO₂ at a molar ratio of 1.01:0.60:0.38:0.02 in a planetary ball mill having a rotation speed of 200 r/min for 5 hours; sintering the fully mixed mixture of Li₂CO₃, CoCO₃, nano Al₂O₃ and nano TiO₂ in air at 800° C. for 18 hours;

Mixing and milling P₂O₅ with the sintered mixture at a mass ratio of 0.01:1 in a planetary ball mill having a rotation speed of 300 r/min for 5 hours; sintering the fully milled mixture in air at 750° C. for 10 hours and obtaining a positive active material including a core of Li_{0.98}Co_{0.6}Al_{0.38}Ti_{0.02}O₂ and a coating layer of Li_{0.98}Co_{0.6}Al_{0.38}Ti_{0.02}PO₄.

### Example 20

The positive active material of Example 20 includes a core of Li_{1.02}Ni_{0.85}Co_{0.10}Al_{0.05}O₂ obtained via coprecipitation method and 0.45 wt % of coating layer of Li_{1.02}Ni_{0.85}Co_{0.10}Al_{0.05}PO₄ having a thickness of 15˜20 nm The average particle size of the secondary particles of the core of Li_{1.02}Ni_{0.85}Co_{0.10}Al_{0.05}O₂ is 7.5˜12.5 μm and the average particle size of the primary particles of the core of Li_{1.02}Ni_{0.85}Co_{0.10}Al_{0.05}O₂ is 0.8˜1.2 μm.

The method for preparing the positive active material of Example 20 includes the steps of:

Dissolving NiSO₄, CoSO₄, Al(NO₃)₃ at an atom ratio of 0.85:0.10:0.05 in deionized water and obtaining a mixed solution having a concentration of 1 mol/L; adding 1 mol/L NaOH solution into the mixed solution and stirring, and maintaining the temperature at 75° C. as well as dripping ammonia into the mixed solution to maintain the pH value at 10.6; obtaining coprecipitate of loose ball shaped secondary particles consisting of secondary particles formed by primary particle having an average particles size of 0.8˜1.2 μm after full reaction; washing the coprecipitate with deionized water and ethanol repeatedly; sintering the washed coprecipitate in air at 500° C. for 5 hours; fully mixing the sintered coprecipitate with LiOH.H₂O and sintering the mixture of the coprecipitate and LiOH.H₂O in air at 750° C. for 10 hours, and obtaining a core of Li_{1.02}Ni_{0.85}Co_{0.10}Al_{0.05}O₂.

Mixing and milling P₂O₅ with the core of Li_{1.02}Ni_{0.85}Co_{0.10}Al_{0.05}O₂ at a mass ratio of 0.0025:1 in a planetary ball mill having a rotation speed of 300 r/min for 5 hours; sintering the fully milled mixture in air at 750° C. for 10 hours and obtaining a positive active material including a core of Li_{1.02}Ni_{0.85}Co_{0.10}Al_{0.05}O₂ and a coating layer of Li_{1.02}Ni_{0.85}Co_{0.10}Al_{0.05}PO₄.

### Example 21

The positive active material of Example 21 includes a core of Li_{1.05}Ni_{0.90}Co_{0.08}Al_{0.02}O₂ obtained via sol-gel method and 2.5 wt % of coating layer of Li_{1.05}Ni_{0.90}Co_{0.08}Al_{0.02}PO₄ having a thickness of 100˜150 nm The core of Li_{1.05}Ni_{0.90}Co_{0.08}Al_{0.02}O₂ is consisted of primary particles and has an average particle size 3.5˜5.5μm.

The method for preparing the positive active material of Example 21 includes the steps of:

Dissolving lithium acetate, nickel acetate, cobalt acetate, aluminum nitrate at an atom ratio of 1.09:0.90:0.08:0.02 in deionized water in a container and obtaining a mixed solution; adding citric acid into the mixed solution after lithium acetate, nickel acetate, cobalt acetate, aluminum nitrate being fully dissolved, the ratio of citric acid to the total metal ions is 2:1; stirring the mixed solution in the container in a water bath at 85° C. to evaporate the water and obtain gelatinous substance; placing the container in an oven at 160° C. for 5 hours, and obtaining brown-black substance; milling the brown-black substance into powder, sintering the powder in air at 750° C. for 5 hours and obtaining a core of Li_{1.05}Ni_{0.90}Co_{0.08}Al_{0.02}O₂;

Dispersing the sintered core of Li_{1.05}Ni_{0.90}Co_{0.08}Al_{0.02}O₂ in 0.8% phosphoric acid solution at a concentration of 500 gL and obtaining a mixed solution; setting the mixed solution in water bath of 85° C. to evaporate the water and obtain gelatinous substance; sintering the gelatinous substance in air at 750° C. for 5 hours, and obtaining a positive active material including a core of Li_{1.05}Ni_{0.90}Co_{0.08}Al_{0.02}O₂ and a coating layer of Li_{1.05}Ni_{0.90}Co_{0.08}Al_{0.02}PO₄.

### Example 22

The positive active material of Example 22 includes a core of Li_{1.09}Ni_{0.88}Co_{0.10}Al_{0.01}Ti_{0.01}O₂ obtained via sol-gel method and 0.80 wt % of coating layer of Li_{1.09}Ni_{0.88}Co_{0.10}Al_{0.01}Ti_{0.01}PO₄ having a thickness of 50˜80 nm The average particle size of the secondary particles of the core of Li_{1.09}Ni_{0.88}Co_{0.10}Al_{0.01}Ti_{0.01}O₂ is 10.5˜13.0 μm and the average particle size of the primary particles of the core of Li_{1.09}Ni_{0.88}Co_{0.10}Al_{0.01}Ti_{0.01}O₂ is 0.4˜0.8 μm.

The method for preparing the positive active material of Example 22 includes the steps of:

Dissolving lithium acetate, nickel acetate, cobalt acetate, aluminum nitrate, nano titanium dioxide at an atom ratio of 1.11:0.88:0.10:0.01:0.01 in deionized water in a container and obtaining a mixed solution; adding citric acid into the mixed solution after lithium acetate, nickel acetate, cobalt acetate, aluminum nitrate, nano titanium dioxide being fully dissolved, the ratio of citric acid to the total metal ions is 2:1; stirring the mixed solution in the container in a water bath at 85° C. to evaporate the water and obtain gelatinous substance; placing the container in an oven at 160° C. for 5 hours, and obtaining brown-black substance; milling the brown-black substance into powder, sintering the powder in air at 750° C. for 5 hours and obtaining a core of Li_{1.09}Ni_{0.88}Co_{0.10}Al_{0.01}Li_{0.01}O₂;

Dispersing the sintered core of Li_{1.09}Ni_{0.88}Co_{0.10}Al_{0.01}Ti_{0.01}O₂ in 0.3% phosphoric acid solution at a concentration of 500gL and obtaining a mixed solution; placing the solution in a water bath of 85° C. to evaporate the water and obtain gelatinous substance; sintering the gelatinous substance in air at 600° C. for 18 hours, and obtaining a positive active material including a core of Li_{1.09}Ni_{0.88}Co_{0.10}Al_{0.01}Ti_{0.01}O₂ and a coating layer of Li_{1.09}Ni_{0.88}Co_{0.10}Al_{0.01}Ti_{0.01}PO₄.

### Example 23

The positive active material of Example 23 includes a core of Li_{0.08}Ni_{0.50}Mn_{0.50}O₂ obtained via solvothermal method and 2.10 wt % of coating layer of Li_{0.08}Ni_{0.50}Mn_{0.50}PO₄ having a thickness of 80˜100 nm The average particle size of the secondary particles of the core of Li_{0.08}Ni_{0.50}Mn_{0.50}O₂ is 8.0˜12.5 μm and the average particle size of the primary particles of the core of Li_{0.08}Ni_{0.50}Mn_{0.50}O₂ is 0.8˜1.0 μm.

The method for preparing the positive active material of Example 23 includes the steps of:

Dissolving nickel acetate and manganese acetate at an atom ratio of 0.50:0.50 in deionized water in a container and obtaining a mixed solution; adding sodium persulfate in the mixed solution after nickel acetate and manganese acetate being fully dissolved in the deionized water, with the ratio of sodium persulfate to the metal ions being 2:1; placing the container containing mixed solution in a PTFE airtight container and placing the container in a stainless steel housing, and putting the container enclosed by the housing in an oven at 135° C. and reacting for 24 hours; after cooling down, washing the reaction product repeatedly with deionized water; sintering the mixture of the washed reaction product and LiOH.H₂O in air at 750° C. for 10 hours, and obtaining a core of Li_{0.08}Ni_{0.50}Mn_{0.50}O₂.

Dispersing the sintered core powder of Li_{0.98}Ni_{0.50}Mn_{0.50}O₂ in 0.8% phosphoric acid solution at a concentration of 500 g/L and obtaining a mixed solution; setting the mixed solution in a water bath of 85° C. to evaporate the water and obtain gelatinous substance; sintering the gelatinous substance in air at 800° C. for 20 hours, and obtaining a positive active material including a core of Li_{0.98}Ni_{0.50}Mn_{0.50}O₂ and a coating layer of Li_{0.98}Ni_{0.50}Mn_{0.50}PO₄.

### Example 24

The positive active material of Example 24 includes a core of Li_{1.07}Ni_{0.80}Mn_{0.20}O₂ obtained via coprecipitation method and 0.05 wt % of coating layer of Li_{1.07}Ni_{0.80}Mn_{0.20}PO₄ having a thickness of 100˜150 nm The average particle size of the secondary particles of the core of Li_{1.07}Ni_{0.80}Mn_{0.20}O₂ is 20.0˜30.0 μm and the average particle size of the primary particles of the core of Li_{1.07}Ni_{0.80}Mn_{0.20}O₂ is 0.4˜0.6 μm.

The method for preparing the positive active material of Example 24 includes the steps of:

Dissolving NiSO₄ and MnSO₄ at an atom ratio of 0.80:0.20 in deionized water and obtaining a mixed solution having a concentration of 1 mol/L; adding 1 mol/L NaOH solution into the mixed solution and stirring, and maintaining the temperature at 75° C.; dripping ammonia into the mixed solution to control the pH value of the mixed solution at 10.3; obtaining coprecipitate of loose ball shaped secondary particles after full reaction; washing the coprecipitate with deionized water and ethanol repeatedly; sintering the washed coprecipitate in air at 500° C. for 5 hours; fully mixing the sintered coprecipitate with LiOH.H₂O and sintering the mixture of the coprecipitate and LiOH.H₂O in air at 750° C. for 10 hours, and obtaining a core of Li_{1.07}Ni_{0.80}Mn_{0.20}O₂.

Mixing and milling P₂O₅ with the core of Li_{1.07}Ni_{0.80}Mn_{0.20}O₂ at a mass ratio of 0.0003:1 in a planetary ball mill having a rotation speed of 300 r/min for 5 hours; sintering the fully milled mixture in air at 750° C. for 10 hours and obtaining a positive active material including a core of Li_{1.07}Ni_{0.80}Mn_{0.20}O₂ and a coating layer of Li_{1.07}Ni_{0.80}Mn_{0.20}PO₄.

### Example 25

The positive active material of Example 25 includes a core of Li_{1.04}Ni_{0.85}Mn_{0.12}Al_{0.03}O₂ obtained via sol-gel method and 2.50 wt % of coating layer of Li_{1.04}Ni_{0.85}Mn_{0.12}Al_{0.03}PO₄ having a thickness of 20˜40 nm The average particle size of the secondary particles of the core of Li_{1.04}Ni_{0.85}Mn_{0.12}Al_{0.03}O₂ is 3.0˜5.8 μm and the average particle size of the primary particles of the core of Li_{1.04}Ni_{0.85}Mn_{0.12}Al_{0.03}O₂ is 0.5˜0.8 μm.

The method for preparing the positive active material of Example 25 includes the steps of:

Dissolving lithium acetate, nickel acetate, manganese acetate, aluminum nitrate at an atom ratio of 1.07:0.85:0.12:0.03 in deionized water in a container and obtaining a mixed solution; adding citric acid into the mixed solution after lithium acetate, nickel acetate, manganese acetate, aluminum nitrate being fully dissolved, with the ratio of citric acid to the total metal ions being 2:1; setting the container having the mixed solution in a water bath of 85° C. to evaporate the water and obtain gelatinous substance; placing the container in an oven at 160° C. for 5 hours, and obtaining brown-black substance; milling the brown-black substance into powder, sintering the powder in air at 750° C. for 25 hours and obtaining a core of Li_{1.04}Ni_{0.85}Mn_{0.12}Al_{0.03}O₂;

Dispersing the sintered core powder of Li_{1.04}Ni_{0.85}Mn_{0.12}Al_{0.03}O₂ in 0.8% phosphoric acid solution at a concentration of 500 g/L and obtaining a mixed solution; setting the mixed solution in a water bath of 85° C. to evaporate the water and obtain gelatinous substance; sintering the gelatinous substance in air at 600° C. for 20 hours, and obtaining a positive active material including a core of Li_{1.04}Ni_{0.85}Mn_{0.12}Al_{0.03}O₂ and a coating layer of Li_{1.04}Ni_{0.85}Mn_{0.12}Al_{0.03}PO₄.

### Comparative Example 1

The positive active material of Comparative Example 1 includes a core of Li_{1.09}Ni_{0.1}Co_{0.5}Mn_{0.4}O₂ obtained via coprecipitation method and 0.03 wt % of coating layer of Al₂O₃ having a thickness of 50-100 nm The average particle size of the secondary particles of the core of Li_{1.09}Ni_{0.1}Co_{0.5}Mn_{0.4}O₂ is 30-55 μm and the average particle size of the primary particles of the core of Li_{1.09}Ni_{0.1}Co_{0.5}Mn_{0.4}O₂ is 4.0-6.0 μm.

The method for preparing the positive active material of Comparative Example 1 includes the steps of:

Dissolving NiSO₄, CoSO₄, MnSO₄ at an atom ratio of 0.1:0.5:0.4 in deionized water and obtaining a mixed solution having a concentration of 1 mol/L; adding 1 mol/L NaOH solution into the mixed solution and stirring, and maintaining the temperature at 75° C.; obtaining coprecipitate of loose ball shaped secondary particles having an average particles size of 30-60 μm after full reaction; washing the coprecipitate with deionized water and ethanol for several times; sintering the washed coprecipitate in air at 500° C. for 5 hours; fully mixing the sintered coprecipitate with LiOH.H₂O and sintering the mixture of the coprecipitate and LiOH.H₂O in air at 900° C. for 20 hours, and obtaining a core of Li_{1.09}Ni_{0.1}Co_{0.5}Mn_{0.4}O₂ consisting of secondary particles formed by primary particles having a particle size of 4.0-6.0 μm.

Mixing nano Al₂O₃ powder with the core of Li_{1.09}Ni_{0.1}Co_{0.5}Mn_{0.4}O₂ at a mass ratio of 0.003:0.97; milling the mixture of nano Al₂O₃ powder and the core of Li_{1.09}Ni_{0.1}Co_{0.5}Mn_{0.4}O₂ in a planetary ball mill having a rotation speed of 300 r/min for 5 hours; sintering the fully milled mixture in air at 900° C. for 10 hours and obtaining a positive active material including a core of Li_{1.09}Ni_{0.1}Co_{0.5}Mn_{0.4}O₂ and a coating layer of Al₂O₃.

Comparative Example 2

The positive active material of Comparative Example 2 is Li_{1.10}Ni_{1/3}Co_{1/3}Mn_{1/3}O₂ obtained via coprecipitation method having an average particle size of the secondary particles of 10-12 μm and an average particle size of the primary particles of 0.8-1.0 μm.

The method for preparing the positive active material of Comparative Example 2 includes the steps of:

Dissolving NiSO₄, CoSO₄, MnSO₄ at an atom ratio of 1.0:1.0:1.0 in deionized water and obtaining a mixed solution having a concentration of 1 mol/L; adding 1 mol/L NaOH solution into the mixed solution and stirring, and maintaining the temperature at 75° C.; obtaining coprecipitate of loose ball shaped secondary particles having an average particles size of 10-13 μm after full reaction; washing the coprecipitate with deionized water and ethanol repeatedly; sintering the washed coprecipitate in air at 500° C. for 5 hours; fully mixing the sintered coprecipitate with LiOH.H₂O and sintering the mixture of the coprecipitate and LiOH.H₂O in air at 850° C. for 10 hours, and obtaining positive active material of Li_{1.10}Ni_{1/3}Co_{1/3}Mn_{1/3}O₂ consisting of secondary particles formed by primary particles having a particle size of 0.8-1.0 μm.

### Comparative Example 3

The positive active material of Comparative Example 3 is Li_{1.08}Ni_{0.5}Co_{0.2}Mn_{0.3}O₂ obtained via coprecipitation method having an average particle size of the secondary particles of 8-12 μm and an average particle size of the primary particles of 0.6-0.8 μm.

The method for preparing the positive active material of Comparative Example 3 includes the steps of:

Dissolving NiSO₄, CoSO₄, MnSO₄ at an atom ratio of 5.0:2.0:3.0 in deionized water and obtaining a mixed solution having a concentration of 1 mol/L; adding 1 mol/L NaOH solution into the mixed solution and stirring, and maintaining the temperature at 75° C.; obtaining coprecipitate of loose ball shaped secondary particles having an average particles size of 8.0-12.5 μm after full reaction; washing the coprecipitate with deionized water and ethanol repeatedly; sintering the washed coprecipitate in air at 500° C. for 5 hours; fully mixing the sintered coprecipitate with LiOH.H₂O and sintering the mixture of the coprecipitate and LiOH.H₂O in air at 800° C. for 10 hours, and obtaining positive active material of Li_{1.08}Ni_{0.5}Co_{0.2}Mn_{0.3}O₂.

### Comparative Example 4

The positive active material of Comparative Example 4 is Li_{0.98}Ni_{0.6}Co_{0.2}Mn_{0.2}O₂ obtained via sol-gel method having an average particle size of 0.1-0.45 μm.

The method for preparing the positive active material of Comparative Example 4 includes the steps of:

Dissolving lithium acetate, nickel acetate, cobalt acetate, manganese acetate at an atom ratio of 0.99:0.60:0.20:0.20 in deionized water in a container and obtaining a mixed solution; adding citric acid into the mixed solution after lithium acetate, nickel acetate, cobalt acetate, manganese acetate being fully dissolved, with the ratio of citric acid to the total metal ions being 2:1; stirring the mixed solution in the container in a water bath of 85° C. to evaporate the water and obtain gelatinous substance; placing the container in an oven at 160° C. for 5 hours, and obtaining brown-black substance; milling the brown-black substance into powder, sintering the powder in air at 750° C. for 10 hours and obtaining positive active material of Li_{0.98}Ni_{0.6}Co_{0.2}Mn_{0.2}O₂;

### Comparative Example 5

The positive active material of Comparative Example 5 includes a core of Li_{0.9}Ni_{0.75}Co_{0.15}Mn_{0.1}O₂ obtained via coprecipitation method and 0.05 wt % of coating layer of MgO having a thickness of 10-15 nm The average particle size of the secondary particles of the core of Li_{0.9}Ni_{0.75}Co_{0.15}Mn_{0.1}O₂O₂ is 7.0-10.0 μm and the average particle size of the primary particles of the core of Li_{0.9}Ni_{0.75}Co_{0.15}Mn_{0.1}O₂ is 0.7-0.9 μm.

The method for preparing the positive active material of Comparative Example 5 includes the steps of:

Dissolving NiSO₄, CoSO₄, MnSO₄ at an atom ratio of 0.75:0.15:0.10 in deionized water and obtaining a mixed solution having a concentration of 1 mol/L; adding 1 mol/L NaOH solution into the mixed solution and stirring, and maintaining the temperature at 75° C.; obtaining coprecipitate of loose ball shaped secondary particles having an average particles size of 7.5-11.0 μm after full reaction; washing the coprecipitate with deionized water and ethanol repeatedly; mixing the washed coprecipitate with LiOH.H₂O and sintering the mixture of the washed coprecipitate an LiOH.H₂O in air at 700° C. for 5 hours, and obtaining a core of Li_{0.9}Ni_{0.75}Co_{0.15}Mn_{0.1}O₂ consisting of secondary particles formed by primary particles having a particle size of 4.0-6.0 μm.

Mixing and milling nano MgO powder with a core of Li_{0.9}Ni_{0.75}Co_{0.15}Mn_{0.1}O₂ at a mass ratio of 0.0005:1 in a planetary ball mill having a rotation speed of 500 r/min for 5 hours; sintering the fully milled mixture in air at 900° C. for 10 hours and obtaining a positive active material including a core of Li_{0.9}Ni_{0.75}Co_{0.15}Mn_{0.1}O₂ and a coating layer of MgO.

### Comparative Example 6

The positive active material of Comparative Example 6 is Li_{1.03}Ni_{0.8}Co_{0.1}Mn_{0.1}O₂ obtained via coprecipitation method having an average particle size of secondary particles of 0.1-0.45 μm and an average particle size of primary particles of 0.7-0.8 μm.

The method for preparing the positive active material of Comparative Example 6 includes the steps of:

Dissolving NiSO₄, CoSO₄, MnSO₄ at an atom ratio of 8.0:1.0:1.0 in deionized water and obtaining a mixed solution having a concentration of 1 mol/L; adding 1 mol/L NaOH solution into the mixed solution and stirring, and maintaining the temperature at 75° C.; obtaining coprecipitate of loose ball shaped secondary particles having an average particles size of 6.3-10.2 μm after full reaction; washing the coprecipitate with deionized water and ethanol repeatedly; sintering the washed coprecipitate in air at 500° C. for 5 hours; fully mixing the sintered coprecipitate with LiOH.H₂O; sintering the mixture of sintered coprecipitate and LiOH.H₂O in air at 900° C. for 8 hours, and obtaining positive active material of Li_{1.03}Ni_{0.8}Co_{0.1}Mn_{0.1}O₂ consisting of secondary particles formed by primary particles having a particle size of 0.7-0.8 μm.

### Comparative Example 7

The positive active material of Comparative Example 7 includes a core of Li_{1.07}Ni_{0.82}Co_{0.1}Mn_{0.08}O₂ obtained via coprecipitation method and 0.12 wt % of coating layer of AlPO₄ having a thickness of 12-15 nm The average particle size of the secondary particles of the core of Li_{1.07}Ni_{0.82}Co_{0.1}Mn_{0.08}O₂ is 15.0-17.0 μm and the average particle size of the primary particles of the core of Li_{1.07}Ni_{0.82}Co_{0.1}Mn_{0.08}O₂ is 0.8-0.9 μm.

The method for preparing the positive active material of Comparative Example 7 includes the steps of:

Dissolving NiSO₄, CoSO₄, MnSO₄ at an atom ratio of 0.82:0.10:0.08 in deionized water and obtaining a mixed solution having a concentration of 1 mol/L; adding 1 mol/L NaOH solution into the mixed solution and stirring, and maintaining the temperature at 75° C.; obtaining coprecipitate of loose ball shaped secondary particles having an average particles size of 15.3-18.0 μm after full reaction; washing the coprecipitate with deionized water and ethanol repeatedly; mixing the washed coprecipitate with LiOH.H₂O and sintering the mixture of the washed coprecipitate and LiOH.H₂O in air at 700° C. for 5 hours, and obtaining a core of Li_{1.07}Ni_{0.82}Co_{0.1}Mn_{0.08}O₂.

Mixing and mixing nano AlPO4 powder with a core of Li_{1.07}Ni₀₈₂Co_{0.1}Mn_{0.08}O₂ at a mass ratio of 0.0012:1 in a planetary ball mill having a rotation speed of 300 r/min for 5 hours; sintering the fully milled mixture in air at 800° C. for 10 hours and obtaining a positive active material including a core of Li_{1.07}Ni_{0.82}Co_{0.1}Mn_{0.08}O₂ and a coating layer of AlPO₄.

### Comparative Example 8

The positive active material of Comparative Example 8 is Li_{0.95}Ni_{0.9}Co_{0.05}Mn_{0.05}O₂ obtained via solid milling method having an average particle size of 10.0˜12.0 μm.

The method for preparing the positive active material of Comparative Example 8 includes the steps of:

Mixing Li₂CO₃, nickel oxalate, cobalt oxalate, MnCO₃ at a molar ratio of 0.49:0.90:0.05:0.05 in a zirconia sander having a rotation speed of 1000 r/min for 5 hours, diameter of the zirconia milling media is 5mm, and the ratio of zirconia milling media to the mixture of Li₂CO₃, nickel oxalate, cobalt oxalate, MnCO₃ is 1:2; removing the zirconia milling media and sintering the remaining mixture in air at 950° C. for 24 hours and obtaining positive active material of Li_{0.95}Ni_{0.0}Co_{0.05}Mn_{0.05}O₂.

### Comparative Example 9

The positive active material of Comparative Example 9 is Li_{1.05}CoO₂ obtained via coprecipitation method having an average particle size of secondary particles of 32˜40 μm and an average particle size of primary particles of 1.0˜2.6 μm.

The method for preparing the positive active material of Comparative Example 9 includes the steps of:

Preparing 1 mol/L CoSO₄ solution; slowly dripping 1 mol/L NH₄HCO₃ solution at a dripping rate of 1 L/h into the CoSO₄ solution; after coprecipitation, filtering and washing the coprecipite with deionized water and obtaining CoCO₃ after drying; mixing Li₂CO₃ and CoCO₃ at a molar ratio of 1.07:1 in a planetary ball mill having a rotation speed of 200 r/min for 5 hours; sintering the fully mixed mixture of Li₂CO₃ and CoCO₃ in air at 900° C. for 10 hours, and obtaining a positive active material Li_{1.05}CoO₂.

### Comparative Example 10

The positive active material of Comparative Example 10 is Li_{1.01}Co_{0.89}Mg_{0.05}Al_{0.04}Ti_{0.02}O₂ obtained via sol-gel method having an average particle size of the secondary particles of 0.1-0.45 μm and an average particle size of the primary particles of 0.5˜0.8 μm.

The method for preparing the positive active material of Comparative Example 10 includes the steps of:

Dissolving lithium acetate, cobalt acetate, nano magnesia, nano alumina, nano titanium dioxide at an atom ratio of 1.03:0.89:0.05:0.04:0.02 in deionized water in a container and obtaining a mixed solution; adding citric acid into the mixed solution after lithium acetate, cobalt acetate, nano magnesia, nano alumina, nano titanium dioxide being fully dissolved, the ratio of citric acid to the total metal ions is 2:1; stirring the solution in the container in a water bath of 85° C. to evaporate the water and obtain gelatinous substance; placing the container in an oven at 160° C. for 5 hours, and obtaining brown-black substance; milling the brown-black substance into powder, sintering the powder in air at 900° C. for 24 hours and obtaining positive active material of Li_{1.01}Co_{0.89}Mg_{0.05}Al_{0.04}Ti_{0.02}O₂.

### Comparative Example 11

The positive active material of Comparative Example 11 is Li_{0.98}Co_{0.98}Ti_{0.02}O₂ obtained via coprecipitation method consisting of monocrystallines having a size of 15˜20 μm.

The method for preparing the positive active material of Comparative Example 11 includes the steps of:

Preparing 1 mol/L CoSO₄ solution; slowly dripping 1 mol/L NH₄HCO₃ solution at a dripping rate of 1 L/h into the CoSO₄ solution; after coprecipitation, filtering and washing the coprecipitate with deionized water, and obtaining CoCO₃ after drying; mixing Li₂CO₃, CoCO₃ and TiO₂ at a molar ratio of 1.01:0.98:0.02 in a planetary ball mill having a rotation speed of 200 r/min for 5 hours; sintering the fully mixed mixture of Li₂CO₃, CoCO₃ and TiO₂ in air at 800° C. for 18 hours, and obtaining a positive active material of Li_{0.98}Co_{0.98}Ti_{0.02}O₂.

### Comparative Example 12

The positive active material of Comparative Example 12 is Li_{1.02}Ni_{0.85}Co_{0.10}Al_{0.05}O₂ obtained via coprecipitation method having an average particle size of the secondary particles of 7.512.5 μm and an average particle size of the primary particles of 0.8˜1.6 μm.

The method for preparing the positive active material of Comparative Example 12 includes the steps of:

Dissolving NiSO₄, CoSO₄, Al(NO₃)₃ at an atom ratio of 0.85:0.10:0.05 in deionized water and obtaining a mixed solution having a concentration of 1 mol/L; adding 1 mol/L NaOH solution into the mixed solution and stirring, and maintaining the temperature at 75° C. ; dripping ammonia in the mixed solution to control the pH value of the mixed solution at 10.6; obtaining coprecipitate of loose ball shaped secondary particles consisting of primary particles having an average particles size of 800˜1200 nm after full reaction; washing the coprecipitate with deionized water and ethanol repeatedly; sintering the washed coprecipitate in air at 500° C. for 5 hours; mixing the sintered coprecipitate with LiOH.H₂O and sintering the mixture of the sintered coprecipitate and LiOH.H₂O in air at 750° C. for 10 hours, and obtaining positive active material of Li_{1.02}Ni_{0.85}Co_{0.10}Al_{0.05}O₂.

### Comparative Example 13

The positive active material of Comparative Example 13 is Li_{1.05}Ni_{0.90}Co_{0.08}Al_{0.02}O₂ obtained via sol-gel method consisting of monocrystallines having an average particle size of 3.55.5μm.

The method for preparing the positive active material of Comparative Example 13 includes the steps of:

Dissolving lithium acetate, nickel acetate, cobalt acetate, aluminum nitrate at an atom ratio of 1.09:0.90:0.08:0.02 in deionized water in a container and obtaining a mixed solution; adding citric acid into the mixed solution after lithium acetate, nickel acetate, cobalt acetate, aluminum nitrate being fully dissolved, the ratio of the citric acid to the total metal ions is 2:1; stirring the mixed solution in the container in a water bath of 85° C. to evaporate the water and obtain gelatinous substance; placing the container in an oven at 160° C. for 5 hours, and obtaining brown-black substance; milling the brown-black substance into powder, sintering the powder in air at 750° C. for 5 hours and obtaining positive active material of Li_{1.05}Ni_{0.90}Co_{0.08}Al_{0.02}O₂

Comparative Example 14

The positive active material of Comparative Example 14 is Li_{1.09}Ni_{0.88}Co_{0.10}Al_{0.01}Ti_{0.01}O₂ obtained via sol-gel method having an average particle size of the secondary particles of 10.5˜13.0 μm and an average particle size of the primary particles of 0.5˜0.8 μm.

The method for preparing the positive active material of Comparative Example 14 includes the steps of:

Dissolving lithium acetate, nickel acetate, cobalt acetate, aluminum nitrate, nano titanium dioxide at an atom ratio of 1.11:0.88:0.10:0.01:0.01 in deionized water in a container and obtaining a mixed solution; adding citric acid into the mixed solution after lithium acetate, nickel acetate, cobalt acetate, aluminum nitrate, nano titanium dioxide being fully dissolved, the ratio of the citric acid to the total metal ions is 2:1; stirring the mixed solution in the container in a water bath of 85° C. to evaporate the water and obtain gelatinous substance; placing the container in an oven at 160° C. for 5 hours, and obtaining brown-black substance; milling the brown-black substance into powder, sintering the powder in air at 750° C. for 5 hours and obtaining positive active material of Li_{1.09}Ni_{0.88}Co_{0.10}Al_{0.01}Ti_{0.01}O₂.

### Comparative Example 15

The positive active material of Comparative Example 15 is Li_{0.98}Ni_{0.50}Mn_{0.50}O₂ obtained via sol-gel method having an average particle size of the secondary particles of 8.0˜12.5 μm and an average particle size of the primary particles of 1.0˜1.3 μm.

The method for preparing the positive active material of Comparative Example 15 includes the steps of:

Dissolving lithium acetate, nickel acetate, manganese acetate at an atom ratio of 1.02:0.50:0.50 in deionized water in a container and obtaining a mixed solution; adding citric acid into the mixed solution after lithium acetate, nickel acetate, manganese acetate being fully dissolved, the ratio of the citric acid to the total metal ions is 2:1; stirring the mixed solution in the container in a water bath of 85° C. to evaporate the water and obtain gelatinous substance; placing the container in an oven at 160° C. for 5 hours, and obtaining brown-black substance; milling the brown-black substance into powder, sintering the powder in air at 750° C. for 5 hours and obtaining positive active material of Li_{0.98}Ni_{0.50}Mn_{0.50}O₂.

### Comparative Example 16

The positive active material of Comparative Example 16 is Li_{1.07}Ni_{0.80}Mn_{0.20}O₂ obtained via coprecipitation method having an average particle size of the secondary particles of 20.0˜30.0 μm and an average particle size of the primary particles of 1.5-1.8 μm.

The method for preparing the positive active material of Comparative Example 16 includes the steps of:

Dissolving NiSO₄, MnSO₄ at an atom ratio of 0.80:0.20 in deionized water and obtaining a mixed solution having a concentration of 1 mol/L; adding 1 mol/L NaOH solution into the mixed solution and stirring, and maintaining the temperature at 75° C.; dripping ammonia in the mixed solution to control the pH value of the mixed solution at 10.3; obtaining coprecipitate of loose ball shaped secondary particles after full reaction; washing the coprecipitate with deionized water and ethanol repeatedly; sintering the washed coprecipitate in air at 500° C. for 5 hours; fully mixing the sintered coprecipitate and LiOH.H₂O; sintering the mixture of the sintered coprecipitate and LiOH.H₂O in air at 750° C. for 10 hours, and obtaining positive active material of Li_{1.07}Ni_{0.80}Mn_{0.20}O₂.

### Comparative Example 17

The positive active material of Comparative Example 17 is Li_{1.04}Ni_{0.85}Mn_{0.12}Al_{0.03}O₂ obtained via sol-gel method consisting of monocrystallines having an average particle size of 3.0˜5.8 μm.

The method for preparing the positive active material of Comparative Example 17 includes the steps of:

Dissolving lithium acetate, nickel acetate, manganese acetate, aluminum nitrate at an atom ratio of 1.07:0.85:0.12:0.03 in deionized water in a container and obtaining a mixed solution; adding citric acid into the mixed solution after lithium acetate, nickel acetate, manganese acetate, aluminum nitrate being fully dissolved, the ratio of the citric acid to the total metal ions is 2:1; stirring the mixed solution in the container in a water bath of 85° C. to evaporate the water and obtain gelatinous substance; placing the container in an oven at 160° C. for 5 hours, and obtaining brown-black substance; milling the brown-black substance into powder, sintering the powder in air at 750° C. for 5 hours and obtaining positive active material of Li_{1.04}Ni_{0.85}Mn_{0.12}Al_{0.03}O₂.

Preparation of Lithium Ion Batteries

The positive active materials according to Examples 1 to 25,Comparative Examples 1 to 17 are adoped as positive active materials to manufacture lithium ion batteries via same process to analyze the electrochemical performance of lithium-containing transition metal oxides. The method for preparing lithium ion batteries includes the following steps.

The positive active materials according to Examples 1 to 25,Comparative Examples 1 to 17 are adopted as positive active materials of the positive plates, respectively. Artificial graphite is adopted as negative active material of the negative plate. The positive plate, the negative plate and the separator are winded to form a lithium ion battery after soldering terminal, packaging the aluminum foil, filling electrolyte and pumping the air. The discharge cut-off voltage of each lithium ion battery is 2.80V. The charge cut-off voltage of each lithium ion battery is 4.50V (relative to the electric potential of lithium 4.55V). The design capacity of each lithium ion battery is 2500 mAh.

Performance Analysis

The performances of lithium ion batteries according to Examples 1 to 25 and Comparative Examples 1 to 17 are assessed and shown in Table 1.

Cycling performance: Each lithium ion battery is charged at a constant current of 0.5 C (1225 mA) at 25 ° Cuntil the voltage reaches 4.50V. Each lithium ion battery is then charged at a constant voltage of 4.50V until the current reaches 0.05 C (123 mA). Each lithium ion battery is further discharged at a constant current of 0.5 C (1225 mA) until the voltage reaches 2.80V. The charging and discharging cycle is repeatedly carried out for 1000 times. The discharge capacity of the first cycle and the discharge capacity of the 1000th cycle are determined. The capacity retention rate of each lithium ion battery is calculated according to the following formular:

The capacity retention rate =(discharge capacity of the 1000th Cycle/discharge capacity of the first cycle)×100%.

High temperature storage performance: Each lithium ion battery is charged at a constant current of 0.5 C (1225 mA) at 25° C. until the voltage reaches 4.50V. Each lithium ion battery is charged at a constant voltage of 4.50V until the current reaches 0.05 C (123 mA). The thickness of each lithium ion battery prior to storage is determined. Each fully charged lithium ion battery is stored in an oven at 60° C. for 100 days. The thickness of each lithium ion battery after storage is determined. The expansion rate of each lithium ion battery after storage is caculated. Each stored lithium ion battery is charged at a constant current of 0.5 C (1225 mA) until the voltage reaches 4.50V. Each lithium ion battery is charged at a constant voltage of 4.50V until the current reaches 0.05 C (123 mA). Each lithium ion battery is discharged at a constant current of 0.5 C (1225 mA) until the voltage reaches 2.80V. The charge and discharge cycle is repeated for five cycles. The final discharge capacity is recorded. The capacity retention rate relative to the first discharge capacity is calculated according to the following formula.

Expansion rate of a stored lithium ion battery=(thickness of a stored lithium ion battery−thickness of a lithium ion battery prior to storage) thickness of a lithium ion battery prior to storage×100%.

Capacity retention rate of a stored lithium ion battery=(discharge capacity after 100 days storage)/(discharge capacity of the first cycle) ×100%.

Safety performance test: Each lithium ion battery is charged at a constant current of 0.5 C (1225 mA) at 25° C. until the voltage reaches 4.50V. Each lithium ion battery is charged at a constant voltage of 4.50V until the current reaches 0.05 C (123 mA). Each lithium ion battery is disassembled in a glovebox full of Argon. The positive plate of each lithium ion battery is taken out and washed in DMC solution. After the DMC has completely evaporated, the positive active material is scratched from the positive plate. 10 mg scratched positive active material of each lithium ion battery is put in an aluminum crucible. The aluminum crucible is sealed after 0.1 μL electrolyte has been added. The scanning temperature of the DSC test is 50˜500° C. and the heating rate is 10° C/min

TABLE 1
Performance Test Results of lithium ion batteries
according to Examples and Comparative Examples

| | Capacity | | Capacity | | |
|---|---|---|---|---|---|
| | retention | Expansion | retention | | |
| | rate of | rate of | rate of a | | Maximum |
| | circled | stored | stored | DSC | DSC |
| | lithium | lithium | lithium | heat | Exo- |
| | ion | ion | ion | re- | thermic |
| | battery | battery | battery | lease(J/g) | peak(° C.) |
| Example 1 | 93.40% | 2.60% | 93.20% | 610 | 298 |
| Example 2 | 96.70% | 1.10% | 97.10% | 649 | 320 |
| Example 3 | 92.30% | 2.30% | 93.10% | 743 | 316 |
| Example 4 | 93.40% | 1.70% | 94.10% | 810 | 304 |
| Example 5 | 91.20% | 1.50% | 90.10% | 840 | 263 |
| Example 6 | 86.15% | 2.60% | 90.00% | 825 | 267 |
| Example 7 | 82.90% | 3.20% | 87.30% | 918 | 245 |
| Example 8 | 84.50% | 1.95% | 91.20% | 890 | 251 |
| Example 9 | 90.20% | 1.20% | 93.10% | 971 | 221 |
| Example 10 | 91.40% | 3.25% | 93.10% | 590 | 338 |
| Example 11 | 97.30% | 0.25% | 96.80% | 810 | 309 |
| Example 12 | 95.60% | 1.55% | 94.90% | 798 | 314 |
| Example 13 | 81.90% | 2.20% | 89.30% | 781 | 272 |
| Example 14 | 97.70% | 0.90% | 98.30% | 621 | 326 |
| Example 15 | 85.40% | 2.90% | 88.60% | 929 | 246 |
| Example 16 | 86.30% | 4.10% | 90.80% | 913 | 257 |
| Example 17 | 73.60% | 10.80% | 82.10% | 1230 | 242 |
| Example 18 | 79.30% | 15.60% | 75.40% | 1160 | 239 |
| Example 19 | 74.90% | 12.10% | 86.10% | 1280 | 240 |
| Example 20 | 69.70% | 15.30% | 90.20% | 920 | 232 |
| Example 21 | 73.80% | 14.90% | 82.30% | 870 | 238 |
| Example 22 | 76.80% | 12.40% | 89.50% | 1021 | 232 |
| Example 23 | 80.30% | 8.90% | 92.00% | 730 | 278 |
| Example 24 | 89.20% | 14.30% | 84.00% | 820 | 242 |
| Example 25 | 78.20% | 16.30% | 89.20% | 876 | 256 |
| Comparative | 77.20% | 5.05% | 82.00% | 691 | 295 |
| Example 1 | | | | | |
| Comparative | 75.80% | 7.10% | 86.20% | 659 | 317 |
| Example 2 | | | | | |
| Comparative | 65.20% | 12.20% | 73.80% | 850 | 296 |
| Example 3 | | | | | |
| Comparative | 52.20% | 23.10% | 61.20% | 865 | 271 |
| Example 4 | | | | | |
| Comparative | 60.70% | 12.05% | 67.50% | 853 | 260 |
| Example 5 | | | | | |
| Comparative | 56.80% | 30.20% | 65.70% | 976 | 237 |
| Example 6 | | | | | |
| Comparative | 57.30% | 25.60% | 70.30% | 950 | 239 |
| Example 7 | | | | | |
| Comparative | 55.60% | 20.50% | 63.50% | 1058 | 215 |
| Example 8 | | | | | |
| Comparative | 60.10% | 25.70% | 50.30% | 1396 | 216 |
| Example 9 | | | | | |
| Comparative | 65.00% | 30.70% | 40.20% | 1378 | 224 |
| Example 10 | | | | | |
| Comparative | 42.60% | 28.10% | 36.00% | 1389 | 228 |
| Example 11 | | | | | |
| Comparative | 56.70% | 29.10% | 70.60% | 1160 | 215 |
| Example 12 | | | | | |
| Comparative | 68.10% | 38.10% | 71.90% | 1260 | 220 |
| Example 13 | | | | | |
| Comparative | 69.00% | 24.10% | 70.60% | 1346 | 209 |
| Example 14 | | | | | |
| Comparative | 72.60% | 18.60% | 70.10% | 860 | 263 |
| Example 15 | | | | | |
| Comparative | 70.90% | 19.70% | 70.60% | 975 | 214 |
| Example 16 | | | | | |
| Comparative | 68.20% | 33.90% | 50.30% | 1057 | 220 |
| Example 17 | | | | | |

It is clearly shown in Table 1 that:

1) The positive active material having coating layer of lithium-containing transition metal oxide according to the present invention has remarkably improved charge-discharge cycle performance at 2.80V˜4.50V. Comparing Examples 1 to 25 and Comparative Examples 1 to 17, after 1000 cycles, the positive active material having coating layer of lithium-containing transition metal oxide according to the present invention has higher capacity retention rate than that of an ordinary lithium containing transition metal oxide positive active material. The positive active material having coating layer of lithium containing transition metal oxide has desirable cycling performance, especially the cycling performance at high voltage of 4.50V, because the coating layer can stabilize the core and prevent phase change.

2) The positive active material having coating layer of lithium-containing transition metal oxide according to the present invention has remarkably improved high temperature storage performance at 4.50V. Comparing Examples 1 to 25 and Comparative Examples 1 to 17, the positive active material having coating layer of lithium-containing transition metal oxide according to the present invention has much lower thickness expansion rate after charged to 4.50v and stored at 60° C. for 100 days than that of an ordinary lithium containing transition metal oxide positive active material. The positive active material having coating layer of lithium containing transition metal oxide has desirable cycling performance The high temperature storage performance at 4.50v is improved remarkably, because the coating layer has high chemical stability and high electrochemical stability. The transition metal element in the coating layer mainly exits in +2, which can remarkably reduce the catalytic activity of the positive active material.

3) The positive active material having coating layer of lithium-containing transition metal oxide according to the present invention has remarkably improved safety performance at 4.50V. Comparing Examples 1 to 25 and Comparative Examples 1 to 17, when the lithium ion battery using the positive active material having coating layer of lithium-containing transition metal oxide according to the present invention is charged to 4.55V, DSC exotherm of the lithium ion battery is much less than that of a lithium ion battery using ordinary lithium containing transition metal oxide positive active material. Phosphate has stable crystal structure. The coating layer of phosphate can improve the thermal stability of the positive active material and improve the safety performance of the lithium ion battery. The coating layer in situ formed on the core can effectively eliminate the sites having high reactivity on the surface of the core, reduce the catalytic activity of the final product in the lithium ion battery and, therefore, obtain stable positive active material.

Summarizing the above, the positive active material and method for preparing the same according to the present invention have the following advantages.

Firstly, the coating layer can conduct lithium ions. Compared with other coating layer of oxide, the coating layer according to the present invention has higher lithium-ion conductivity.

Secondly, the coating layer has stable chemical stability and electrochemical stability. The transition metal in the coating layer has valence of +2. Even after being charged to 4.70V, only small part of the element (Mn) changes its valence, which will remarkably reduce the catalytic activity of the core and improve the chemical stability of the positive active material. In addition, phosphate has stable crystal structure. The coating layer of phosphate can improve the thermal stability of the positive active material, thereby improving the safety performance of the lithium ion battery.

Thirdly, the coating layer is in situ formed on the core. Part of the coating layer comes from the core. Therefore, the coating layer can be uniformly formed on the core.

Fourthly, the coating layer is apt to be formed on the sites having high reactivity of the core. The method according to the present invention can effectively eliminate the sites having high reactivity on the surface of the core, thereby reducing the catalytic activity of the final product in the lithium ion battery and obtaining stable positive active material.

Fifthly, the method according to the present invention can reduce the oxidizing ability of the core in charging state. The M⁴⁺ having strong oxidizing ability on the surface of the core is coated by the coating layer and cannot contact the electrolyte. Therefore, the M⁴⁺ can hardly oxidize and decompose the electrolyte.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments, it should be appreciated that alternative embodiments without departing from the scope of the appended claims. Although specific terms are employed herein, they are used in a generic and descriptive sense only and not for purposes of limitation.

What is claimed is:

1. A positive active material for use in a lithium ion battery, comprising a core of lithium containing transition metal oxide represented by formula LiₓM_{y}N_{1-y}O_{2-α}A_{β} and a coating layer of lithium containing transition metal phosphate represented by formula LiₐM_{b}N′_{1-b}PO_{4-λ}B_{ζ} in situ formed on the core, wherein element represented by M is at least one of Ni, Co and Mn; element represented by N and N′ each is at least one of Na, K, Rb, Cs, Be, Mg, Ca, Sr, Ba, Ra, Al, Ga, In, Ge, Sn, Sc, Ti, V, Cr, Mn, Fe, Co, Ni, Cu, Zn, Y, Zr, Nb, Mo, Ru, Rh, Pd, Ag, Cd, La, Ce, Pr, Nd, Sm, Eu, Gd, Tb, Dy, Ho, Er, Tm, Yb, Lu; element represented by A and B each is at least one of N, F, P, S, Cl, Se; and 0.9≦x≦1.2, 0.6≦y≦1.0, 0.9≦a≦1.1, 0.6≦b≦1.0, 0≦α≦0.2, 0≦β≦0.4, 0≦λ≦0.5, 0≦ζ≦0.5.

2. The positive active material of claim 1, wherein the element represented by N′ is no less than the element represented by N, and the element represented by B is no less than element represented by A.

3. The positive active material of claim 1, wherein particles of the core are primary particles and/or secondary particles.

4. The positive active material of claim 1, wherein a thickness of the coating layer of the lithium containing transition metal phosphate represented by formula LiₐM_{b}N′_{1-b}PO_{4-λ}B_{ζ} is 0.1 nm˜500 nm, or preferably 1 nm˜300 nm.

5. The positive active material of claim 1, wherein a mass content of the lithium containing transition metal phosphate represented by formula LiₐM_{b}N′_{1-b}PO_{4-λ}B_{ζ} in the total positive active material is about 0.01%-30%, or preferably 0.1%˜5.0%.

6. A method for preparing the positive active material of claim 1, comprising the steps of:
preparing the core of lithium containing transition metal oxide represented by formula LiₓM_{y}N_{1-y}O_{2-α}A_{β};
adding P source; and
obtaining the positive active material comprising the core of lithium containing transition metal oxide represented by formula LiₓM_{y}N_{1-y}O_{2-α}A_{β} and the coating layer of lithium containing transition metal phosphate represented by Formula LiₐM_{b}N′_{1-b}PO_{4-λ}B_{ζ} in situ formed on the core via high temperature sintering.

7. The method of claim 6, wherein the P source is at least one of elementary substance P, P₂O₃, P₂O₅, H₃PO₄, H₃PO₃, H₃PO₂, (NH₄)₃PO₄, (NH₄)₂ HPO₄, (NH₄)H₂ PO₄, (NH₄)₃PO₃, (NH₄)₃PO₂, Li₃PO₄, Li₂ HPO₄, LiH₂ PO₄, phosphate ester, phosphite ester, and a compound containing element P and at least two elements of Li, C, H, O, N.

8. The method of claim 6, comprising the steps of:
1) preparing the core of lithium containing transition metal oxide represented by Formula LiₓM_{y}N_{1-y}O_{2-α}A_{β}: preparing oxide, hydroxide or carbonate of transition metal via one of solid milling method, liquid coprecipitation method, sol-gel method, combustion method, solvothermal method, Pechini method; mixing oxide, hydroxide or carbonate of transition metal with lithium source, and sintering the mixture at 600˜1200° C. or preferably at 700-900° C.; or obtaining mixture containing lithium and transition metal via one of solid milling method, sol-gel method, combustion method, Pechini method; and sintering the mixture at 600˜1200° C. or preferably at 700-900° C.;
2) adding P source into the core of lithium containing transition metal oxide represented by formula LiₓM_{y}N_{1-y}O_{2-α}A_{β}: uniformly dispersing the P source in the core represented by formula LiₓM_{y}N_{1-y}O_{2-α}A_{β} via one of solid milling method, sol-gel method, combustion method, Pechini method; and
3) solid phase sintering the mixture in step 2) at 400˜1200° C., or preferably at 500˜900° C., and obtaining the positive active material comprising the core of lithium containing transition metal oxide represented by Formula LiₓM_{y}N_{1-y}O_{2-α}A_{β} and the coating layer of lithium containing transition metal phosphate represented by Formula LiₐM_{b}N′_{1-b}PO_{4-λ}B_{ζ} in situ formed on the core.

9. The method of claim 8, wherein prior to step 3), at least one of NH₄VO₃, Nb₂O₅, ZrO₂, TiO₂, MoO₃, YNO₃ is added into the core, to obtain the coating layer of lithium containing transition metal phosphate represented by Formula LiₐM_{b}N′_{1-b}PO_{4-λ}B_{ζ} which has more element represented by N′ than element represented by N after solid phase sintering in step 3).

10. The method of claim 8, wherein prior to step 3), at least one of NH₄F, LiF, HF, S, H₂S is added into the core, so as to obtain the coating layer of lithium containing transition metal phosphate represented by formula LiₐM_{b}N′_{1-b}PO_{4-λ}B_{ζ} which has more element represented by B than element represented by A after solid phase sintering in step 3).

11. A lithium ion battery, comprising a positive electrode, a negative electrode and a separator between the positive electrode and the negative electrode, wherein the positive electrode comprises the positive active material of claim.

12. The lithium ion battery of claim 11, wherein a cut-off voltage of the lithium ion battery is 4.1-4.7V.
